(19) United States
(12) Patent Application Publication
(10) Pub. No.: US 2024/0161604 A1
(43) Pub. Date: May 16, 2024

(54) Electronic Device and Method for Processing Data in an Intelligent Transport System

(71) Applicant: THINKWARE CORPORATION, Seongnam-si, Gyeonggi-do (KR)

(72) Inventors: Suk Pil KO, Seongnam-si, Gyeonggi-do (KR); Yun Ho AHN, Seongnam-si, Gyeonggi-do (KR); Taekyu HAN, Seongnam-si, Gyeonggi-do (KR)

(73) Assignee: THINKWARE CORPORATION, Seongnam-si, Gyeonggi-do (KR)

(21) Appl. No.: 18/229,797

(22) Filed: Aug. 3, 2023

(30) Foreign Application Priority Data
Aug. 3, 2022 (KR) 10-2022-0096689

(51) Int. Cl. G08G 1/01; G08G 1/00; G08G 1/017; G08G 1/052; G08G 1/056

(52) U.S. Cl. CPC G08G 1/0125; G08G 1/0112; G08G 1/017; G08G 1/052; G08G 1/056; G08G 1/20

(57) ABSTRACT

A method for an electronic device within a server processing data in an intelligent transport system according to one embodiment comprises receiving, from vehicles, information of an ego-vehicle including absolute coordinates of the ego-vehicle and information of surrounding objects including relative coordinates of the surrounding objects recognized by the ego-vehicle and generating integrated object information including absolute coordinates of the respective vehicles based on the received information.

### TECHNICAL FIELD

The present disclosure relates to an electronic device and method for processing data in an intelligent transport system.

### BACKGROUND

The most important thing when driving a vehicle is safety and prevention of traffic accidents; to this end, vehicles are equipped with various auxiliary devices that perform vehicle pose control and function control of vehicle components and safety devices such as seat belts and airbags.

In addition, recently, it has become a common practice to mount devices such as black boxes in a vehicle to store driving images of the vehicle and data transmitted from various sensors for identifying the cause in the event of a vehicle accident.

Also, portable terminals, such as smartphones and tablets, are widely used as vehicle devices due to their capability to run black boxes or navigation applications.

### DETAILED DESCRIPTION

In an intelligent transport system that collects road traffic information related to autonomous driving and provides the collected information to vehicles, a server may collect information of vehicles through communication with the vehicles and process the collected data. Meanwhile, there exist a considerable number of vehicles on the road that are incapable of communicating with the server. Also, even if the number of autonomous driving vehicles is increased due to the advances in autonomous driving technology, autonomous vehicles and non-autonomous vehicles may coexist for a considerable period of time. Therefore, it is necessary to collect and process accurate data about the locations and conditions of objects on the road and provide the data to each vehicle.

In this regard, one embodiment provides a method and apparatus for generating location information of vehicles on the road using data of objects recognized by the vehicles.

One embodiment provides a method and apparatus for generating integrated traffic information using object data received from vehicles.

One embodiment provides a method and apparatus for generating location and driving information of vehicles incapable of communicating with a server.

A method for an electronic device within a server processing data in an intelligent transport system according to one embodiment may include receiving, from vehicles, information of an ego-vehicle including absolute coordinates of the ego-vehicle and information of surrounding objects including relative coordinates of the surrounding objects recognized by the ego-vehicle; and generating integrated object information including absolute coordinates of the respective vehicles based on the received information.

Here, the information of the ego-vehicle may include license plate information of the ego-vehicle; when the surrounding object is a vehicle, the information of the surrounding object may include license plate information of the vehicle, which is the surrounding object.

Here, the generating of the integrated object information may include generating unique identifiers of a plurality of vehicles by using the license plate information of the ego-vehicle and the license plate information of vehicles, which are the surrounding objects, the license plate information being received from the plurality of vehicles; and generating absolute coordinates of the vehicles with the generated unique identifiers.

Here, information of the ego-vehicle may include driving information of the ego-vehicle, wherein the driving information may include at least one of a moving direction, speed, and vehicle type of the ego-vehicle.

Here, the generating of the integrated object information may include generating driving information of vehicles with the unique identifiers based on driving information of the ego-vehicle.

Here, the vehicles may include a plurality of communicating vehicles capable of communicating with the server and at least one non-communicating vehicle incapable of communicating with the server.

Here, the absolute coordinates of the non-communicating vehicle may be generated based on the relative coordinates of the non-communicating vehicle received from at least two predetermined number of communicating vehicles among the plurality of communicating vehicles.

Here, the predetermined number may be determined based on at least one of average speed of vehicles, density of vehicles, and vehicle types.

A method for an electronic device within a vehicle processing data in an intelligent transport system according to one embodiment may comprise obtaining relative coordinates of a surrounding object recognized by the vehicle, transmitting information of an ego-vehicle including absolute coordinates of the vehicle and information of a surrounding object including relative coordinates of the surrounding object to a server, and receiving integrated object information including absolute coordinates of the respective external vehicles generated based on the transmitted information.

Here, the information of the ego-vehicle may include license plate information of the ego-vehicle; when the surrounding object is a vehicle, the information of the surrounding object may include license plate information of the vehicle, which is the surrounding object.

Here, the integrated object information may include absolute coordinates generated for a plurality of vehicles with unique identifiers generated using license plate information of the ego-vehicle and license plate information of the vehicles, which are the surrounding objects, the license plate information being received from the plurality of vehicles.

Here, the information of the ego-vehicle may include driving information of the ego-vehicle, wherein the driving information may include at least one of a moving direction, speed, and vehicle type of the ego-vehicle.

Here, the integrated object information may include driving information generated for the vehicles with the unique identifiers based on the driving information of the ego-vehicle.

Here, the external vehicles may include a plurality of communicating vehicles capable of communicating with the server and at least one non-communicating vehicle incapable of communicating with the server.

Here, the absolute coordinates of the non-communicating vehicle may be generated based on the relative coordinates of the non-communicating vehicle received from at least two or more predetermined number of communicating vehicles among the plurality of communicating vehicles.

Here, the predetermined number may be determined based on at least one of average speed of vehicles, density of vehicles, and vehicle types.

An electronic device within a server processing data in an intelligent transport system according to one embodiment may comprise a communication unit receiving, from vehicles, information of an ego-vehicle including absolute coordinates of the ego-vehicle and information of a surrounding object including relative coordinates of the surrounding object recognized by the ego-vehicle; and a processor generating integrated object information including absolute coordinates of the respective vehicles based on the received information.

Here, the information of the ego-vehicle may include license plate information of the ego-vehicle; when the surrounding object is a vehicle, the information of the surrounding object may include license plate information of the vehicle, which is the surrounding object.

Here, the processor generates unique identifiers of a plurality of vehicles using license plate information of the ego-vehicle and license plate information of the vehicles, which are the surrounding objects, the license plate information being received from the plurality of vehicles and generates absolute coordinates of the vehicles with the generated unique identifiers.

Here, the information of the ego-vehicle may include driving information of the ego-vehicle, wherein the driving information may include at least one of a moving direction, speed, and vehicle type of the ego-vehicle.

Here, the processor generates driving information of vehicles with the unique identifiers based on the driving information of the ego-vehicle.

Here, the vehicles may include a plurality of communicating vehicles capable of communicating with the server and at least one non-communicating vehicle incapable of communicating with the server.

Here, the absolute coordinates of the non-communicating vehicle may be generated based on the relative coordinates of the non-communicating vehicle received from at least two predetermined number of communicating vehicles among the plurality of communicating vehicles.

Here, the predetermined number may be determined based on at least one of average speed of vehicles, density of vehicles, and vehicle types.

An electronic device within a vehicle processing data in an intelligent transport system according to one embodiment may comprise a processor obtaining relative coordinates of a surrounding object recognized by the vehicle and a communication unit transmitting information of an ego-vehicle including absolute coordinates of the vehicle and information of a surrounding object including relative coordinates of the surrounding object to a server and receiving integrated object information including absolute coordinates of the respective external vehicles generated based on the transmitted information.

Here, the information of the ego-vehicle may include license plate information of the ego-vehicle; when the surrounding object is a vehicle, the information of the surrounding in object may include license plate information of the vehicle, which is the surrounding object.

Here, the integrated object information may include absolute coordinates generated for a plurality of vehicles with unique identifiers generated using license plate information of the ego-vehicle and license plate information of the vehicles, which are the surrounding objects, the license plate information being received from the plurality of vehicles.

Here, the information of the ego-vehicle may include driving information of the ego-vehicle, wherein the driving information may include at least one of a moving direction, speed, and vehicle type of the ego-vehicle. Here, the integrated object information may include driving information generated

for the vehicles with the unique identifiers based on the driving information of the ego-vehicle.

Here, the external vehicles may include a plurality of communicating vehicles capable of communicating with the server and at least one non-communicating vehicle incapable of communicating with the server.

Here, the absolute coordinates of the non-communicating vehicle may be generated based on the relative coordinates of the non-communicating vehicle received from at least two or more predetermined number of communicating vehicles among the plurality of communicating vehicles.

Here, the predetermined number may be determined based on at least one of average speed of vehicles, density of vehicles, and vehicle types.

According to the embodiments, highly accurate data on the state of objects on the road may be generated and provided to individual vehicles in an intelligent transport system, which thus helps the efficient driving of vehicles and provides advanced information for deciding the driving of an autonomous driving vehicle. Also, the location and state of a non-communicating vehicle or a non-autonomous vehicle may be estimated with high accuracy even in an environment where non-communicating vehicles and communicating vehicles coexist or while non-autonomous vehicles and autonomous driving vehicles coexist, and thus, a stable and accurate intelligent transport system may be built.

### BRIEF DESCRIPTION OF THE DRAWINGS

The following drawings are made to describe a specific embodiment of the present disclosure. Since the names of specific devices or names of specific signals/messages/fields described in the drawings are provided for an illustrative purpose, the technical features of the present disclosure are not limited to the specific names used in the drawings below.

FIG. 1 is a block diagram illustrating a vehicle service system according to one embodiment.

FIG. 2 is a block diagram illustrating a vehicle electronic device according to one embodiment.

FIG. 3 is a block diagram illustrating a vehicle service providing server according to one embodiment.

FIG. 4 is a block diagram of a user terminal according to one embodiment.

FIG. 5 is a block diagram illustrating an autonomous driving system of a vehicle according to one embodiment.

FIGS. 6 and 7 are block diagrams illustrating an autonomous driving moving body according to one embodiment.

FIG. 8 illustrates constituting elements of a vehicle.

FIG. 9 illustrates the operation of an electronic device that trains a neural network based on a set of training data according to one embodiment.

FIG. 10 is a block diagram of an electronic device according to one embodiment.

FIG. 11 illustrates one example of an intelligent transport system according to one embodiment.

FIG. 12 illustrates one example of processing vehicle data according to one embodiment.

FIG. 13 illustrates the operation of an electronic device within a vehicle according to one embodiment.

FIG. 14 illustrates the operation of an electronic device within a server according to one embodiment.

FIG. 15 is a diagram illustrating an example in which an ego-vehicle driving on a road network acquires absolute coordinate information of the ego-vehicle and relative coordinate information of surrounding vehicles according to an embodiment of the present invention.

FIG. 16 is a diagram illustrating a method of obtaining absolute and relative coordinates of an ego-vehicle according to an embodiment.

FIG. 17 is a diagram illustrating a virtual mesh network coordinate system in a rectangular shape which is generated with the location of the vehicle 1613 as the origin (reference point) according to an embodiment.

FIG. 18 is a flowchart of the operation of an ego vehicle 1610 according to an embodiment.

### DETAILED DESCRIPTION

In what follows, part of embodiments of the present disclosure will be described in

detail with reference to illustrative drawings. In assigning reference symbols to the constituting elements of each drawing, it should be noted that the same constituting elements are intended to have the same symbol as much as possible, even if they are shown on different drawings. Also, in describing an embodiment, if it is determined that a detailed description of a related well-known configuration or function incorporated herein unnecessarily obscure the understanding of the embodiment, the detailed description thereof will be omitted.

Also, in describing the constituting elements of the present disclosure, terms such as first, second, A, B, (a), and (b) may be used. Such terms are intended only to distinguish one constituting element from the others and do not limit the nature, sequence, or order of the constituting element. Also, unless defined otherwise, all the terms used in the present disclosure, including technical or scientific terms, provide the same meaning as understood generally by those skilled in the art to which the present disclosure belongs. Those terms defined in ordinary dictionaries should be interpreted to have the same meaning as conveyed in the context of related technology. Unless otherwise defined explicitly in the present disclosure, those terms should not be interpreted to have ideal or excessively formal meaning.

The expression “A or B” as used in the present disclosure may mean “only A”, “only B”, or “both A and B”. In other words, “A or B” may be interpreted as “A and/or B” in the present disclosure. For example, in the present disclosure, “A, B, or C” may mean “only A”, “only B”, “only C”, or “any combination of A, B and C”.

A slash (/) or a comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

The phrase “at least one of A and B” as used in the present disclosure may mean “only A”, “only B”, or “both A and B”. Also, the expression “at least one of A or B” or “at least one of A and/or B” may be interpreted to be the same as “at least one of A and B”.

Also, the phrase “at least one of A, B and C” as used in the present disclosure may mean “only A”, “only B”, or “any combination of A, B and C”. Also, the phrase “at least one of A, B, or C” or “at least one of A, B, and/or C” may mean “at least one of A, B, and C”.

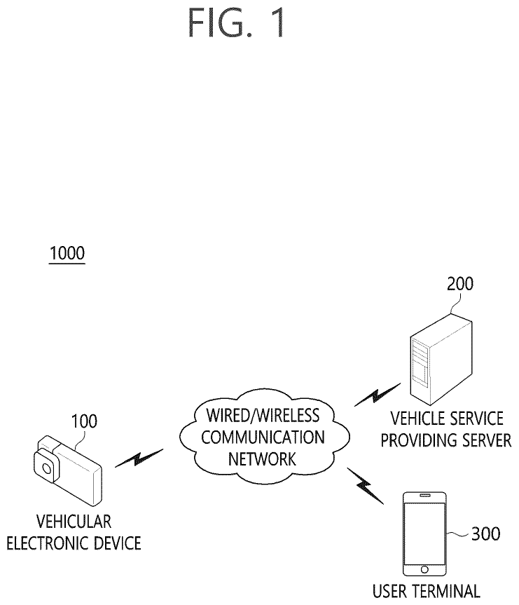

FIG. 1 is a block diagram illustrating a vehicle service system according to one embodiment.

In the present disclosure, a vehicle is an example of a moving body, which is not necessarily limited to the context of a vehicle. A moving body according to the present disclosure may include various mobile objects such as vehicles, people, bicycles, ships, and trains. In what follows, for the convenience of descriptions, it will be assumed that a moving body is a vehicle.

Also, in the present disclosure, a vehicle electronic device may be called other names, such as an infrared camera for a vehicle, a black box for a vehicle, a car dash cam, or a car video recorder.

Also, in the present disclosure, a vehicle service system may include at least one vehicle-related service system among a vehicle black box service system, an advanced driver assistance system (ADAS), a traffic control system, an autonomous driving vehicle service system, a teleoperated vehicle driving system, an AI-based vehicle control system, and a V2X service system.

Referring to FIG. 1, a vehicle service system 1000 includes a vehicle electronic device 100, a vehicle service providing server 200, and a user terminal 300. The vehicle service providing server 200 may access a wired/wireless communication network wirelessly and exchange data with the vehicle service providing server 200 and the user terminal 300 connected to the wired/wireless communication network.

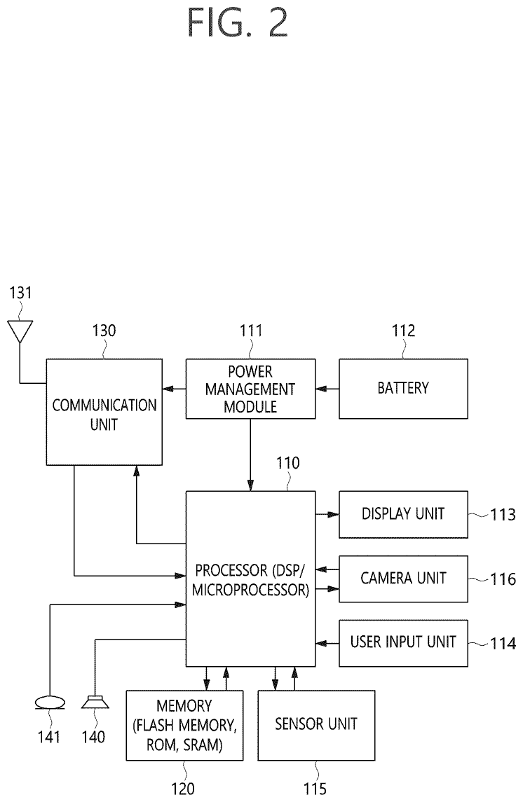

The vehicle electronic device 100 may be controlled by user control applied through the user terminal 300. For example, when a user selects an executable object installed in the user terminal 300, the vehicle electronic device 100 may perform operations corresponding to an event generated by the user input for the executable object. The executable object may be an application installed in the user terminal 300, capable of remotely controlling the vehicle electronic device 100. FIG. 2 is a block diagram illustrating a vehicle electronic device according to one embodiment.

Referring to FIG. 2, the vehicle electronic device 100 includes at least part of a processor 110, a power management module 111, a battery 112, a display unit 113, a user input unit 114, a sensor unit 115, an image capture unit 116, a memory 120, a communication unit 130, one or more antennas 131, a speaker 140, and a microphone 141.

The processor 110 controls the overall operation of the vehicle electronic device 100 and may be configured to implement the proposed function, procedure, and/or method described in the present disclosure. The processor 110 may include an application-specific integrated circuit (ASIC), other chipsets, logic circuits, and/or data processing devices. The processor may be an application processor (AP). The processor 110 may include at least one of a digital signal processor (DSP), a central processing unit (CPU), a graphics processing unit (GPU), and a modulator and demodulator (Modem).

The processor 110 may control all or part of the power management module 111, the battery 112, the display unit 113, the user input unit 114, the sensor unit 115, the image capture unit 116, the memory 120, the communication unit 130, one or more antennas 131, the speaker 140, and the microphone 141. In particular, when various data are received through the communication unit 130, the processor 110 may process the received data to generate a user interface and control the display unit 113 to display the generated user interface. The whole or part of the processor 110 may be electrically or operably coupled with or connected to other constituting elements within the vehicle electronic device 100 (e.g., the power management module 111, the battery 112, the display unit 113, the user input unit 114, the sensor unit 115, the image capture unit 116, the memory 120, the communication unit 130, one or more antennas 131, the speaker 140, and the microphone 141).

The processor 110 may perform a signal processing function for processing image data acquired by the image capture unit 116 and an image analysis function for obtaining on-site information from the image data. For example, the signal processing function includes a function of compressing the image data taken from the image capture unit 116 to reduce the size of the image data. Image data are a collection of multiple frames sequentially arranged along the time axis. In other words, the image data may be regarded as a set of photographs consecutively taken during a given time period. Since image data size is huge when the image data are not compressed, and significant inefficiency is caused when the image data are stored in the memory without compression, compression is performed on the digitally converted image. For video compression, a method using correlation between frames, spatial correlation, and visual characteristics sensitive to low-frequency components is used. Since a portion of the original data is lost from compression, the image data may be compressed at an appropriate ratio, as low as to yield sufficient identification of the traffic accident involving a vehicle. As a video compression method, one of the various video codecs, such as the H.264, MPEG4, H.263, H.265/HEVC, H.266/VVC, AV-1, VP9, etc, may be used, and image data is compressed in a manner supported by the vehicle electronic device 100.

The image analysis function according to an embodiment of the present invention may include functions for detecting and classifying objects present in the image and tracking the detected objects.

Object detection for detecting objects existing in an image according to an embodiment of the present invention may use a deep learning-based object detection model.

Specifically, a two-stage detector model in which regional proposal and detection are performed sequentially such as the R-CNN series (Regions with Convolutional Neural Networks features (R-CNN), Fast R-CNN, Faster R-CNN, Mask R-CNN, etc.), and a one-stage detector model in which regional proposal and detection are performed simultaneously (i.e., region proposal is processed in one stage) such as YOLO (You Only Look) and SSD (Single-Shot Multibox Detector) may be used, but is not limited to this.

The image analysis function may be based on deep learning and implemented by computer vision techniques. Specifically, the image analysis function may include an image segmentation function, which partitions an image into multiple areas or slices and inspects them separately; an object detection function, which identifies specific objects in the image; an advanced object detection model that recognizes multiple objects (e.g., sedan, pickup truck, SUV (Sports Utility Vehicle), bus, truck, pedestrian, bicycle, motorcycle, traffic light, road, crosswalk, etc.) present in one image (where the model uses XY coordinates to generate bounding boxes and identify everything therein); a facial recognition function, which not only recognizes human faces in the image but also identifies individuals; a boundary detection function, which identifies outer boundaries of objects or a scene to more accurately understand the content of the image, a pattern detection function, which recognizes repeated shapes, colors, or other visual indicators in the images; and a feature matching function, which compares similarities of images and classifies the images accordingly.

The image analysis function may be performed by the vehicle service providing server 200, not by the processor 110 of the vehicle electronic device 100.

The power management module 111 manages power for the processor 110 and/or the communication unit 130. The battery 112 provides power to the power management module 111

The display unit 113 outputs results processed by the processor 110.

The display unit 113 may output content, data, or signals. In various embodiments, the display unit 113 may display an image signal processed by the processor 110. For example, the display unit 113 may display a capture or still image. In another example, the display unit 113 may display a video or a camera preview image. In yet another example, the display unit 113 may display a graphical user interface (GUI) to interact with the vehicle electronic device 100. The display unit 113 may include at least one of a liquid crystal display (LCD), a thin film transistor-liquid crystal display, an organic light-emitting diode (OLED), a flexible display, and a 3D display. The display unit 113 may be configured as an integrated touch screen by being coupled with a sensor capable of receiving a touch input.

The user input unit 114 receives an input to be used by the processor 110. The user input unit 114 may be displayed on the display unit 113. The user input unit 114 may sense a touch or hovering input of a finger or a pen. The user input unit 114 may detect an input caused by a rotatable structure or a physical button. The user input unit 114 may include sensors for detecting various types of inputs. The inputs received by the user input unit 114 may have various types. For example, the input received by the user input unit 114 may include touch and release, drag and drop, long touch, force touch, and physical depression.

The input unit 430 may provide the received input and data related to the received input to the control unit 450. In various embodiments, the user input unit 114 may include a microphone or a transducer capable of receiving a user's voice command. In various embodiments, the user input unit 114 may include an image sensor or a camera capable of capturing a user's motion.

The sensor unit 115 includes one or more sensors. The sensor unit 115 has the function of detecting an impact applied to the vehicle or detecting a case where the amount of acceleration change exceeds a certain level. In some embodiments, the sensor unit 115 may be image sensors such as high dynamic range cameras. In some embodiments, the sensor unit 115 includes non-visual sensors. In some embodiments, the sensor unit 115 may include a radar sensor, a light detection and ranging (LiDAR) sensor, and/or an ultrasonic sensor in addition to an image sensor. In some embodiments, the sensor unit 115 may include an acceleration sensor or a geomagnetic field sensor to detect impact or acceleration.

In various embodiments, the sensor unit 115 may be attached at different locations and/or attached to face one or more different directions. For example, the sensor unit 115 may be attached to the front, sides, rear, and/or roof of a vehicle to face the forward-facing, rear-facing, and side-facing directions.

The image capture unit 116 may capture an image in at least one of the situations, including parking, stopping, and driving a vehicle. Here, the captured image may include a parking lot image that is a captured image of the parking lot. The parking lot image may include images captured from when a vehicle enters the parking lot to when the vehicle leaves the parking lot. In other words, the parking lot image may include images taken from when the vehicle enters the parking lot until when the vehicle is parked (e.g., the time the vehicle is turned off to park), the images taken while the vehicle is parked, and the images taken from when the vehicle gets out of the parked state (e.g., the vehicle is started on to leave the parking lot) to when the vehicle leaves the parking lot. The captured image may include at least one image of the front, rear, side, and interior of the vehicle. Also, the image capture unit 116 may include an infrared camera capable of monitoring the driver's face or pupils.

The image capture unit 116 may include a lens unit and an imaging device. The lens unit may perform the function of condensing an optical signal, and an optical signal transmitted through the lens unit reaches an imaging area of the imaging device to form an optical image. Here, the imaging device may use a Charge Coupled Device (CCD), a Complementary Metal Oxide Semiconductor Image Sensor (CIS), or a high-speed image sensor, which converts an optical signal into an electrical signal. Also, the image capture unit 116 may further include all or part of a lens unit driver, an aperture, an aperture driving unit, an imaging device controller, and an image processor.

The operation mode of the vehicle electronic device 100 may include a continuous recording mode, an event recording mode, a manual recording mode, and a parking recording mode.

The continuous recording mode is executed when the vehicle is started up and remains operational while the vehicle continues to drive. In the continuous recording mode, the vehicle image capture device 100 may perform recording in predetermined time units (e.g., 1 to 5 minutes). In the present disclosure, the continuous recording mode and the continuous mode may be used in the same meaning.

The parking recording mode may refer to a mode operating in a parked state when the vehicle's engine is turned off, or the battery supply for vehicle driving is stopped. In the parking recording mode, the vehicle electronic device 100 may operate in the continuous parking recording mode in which continuous recording is performed while the vehicle is parked. Also, in the parking recording mode, the vehicle electronic device 100 may operate in a parking event recording mode in which recording is performed when an impact event is detected during parking. In this case, recording may be performed during a predetermined period ranging from a predetermined time before the occurrence of the event to a predetermined time after the occurrence of the event (e.g., recording from 10 seconds before to 10 seconds after the occurrence of the event). In the present disclosure, the parking recording mode and the parking mode may be used in the same meaning.

The event recording mode may refer to the mode operating at the occurrence of various events while the vehicle is driving.

The manual recording mode may refer to a mode in which a user manually operates recording. In the manual recording mode, the vehicle electronic device 100 may perform recording (e.g., recording of images 10 seconds before to 10 seconds after an event) from a predetermined time before the occurrence of the user's manual recording request to the time after the predetermined time.

The memory 120 is operatively coupled to the processor 110 and stores a variety of information for operating the processor 110. The memory 120 may include a read-only memory (ROM), a random-access memory (RAM), a flash memory, a memory card, a storage medium, and/or other equivalent storage devices. When the embodiment is implemented in software, the techniques explained in the present disclosure may be implemented with a module (i.e., procedure, function, etc.) for performing the functions explained in the present disclosure. The module may be stored in the memory 120 and may be performed by the processor 110. The memory 120 may be implemented inside the processor 110. Alternatively, the memory 120 may be implemented outside the processor 110 and may be coupled to the processor 110 in a communicable manner by using various well-known means.

The memory 120 may be integrated within the vehicle electronic device 100, installed in a detachable form through a port provided by the vehicle electronic device 100, or located externally to the vehicle electronic device 100. When the memory 120 is integrated within the vehicle electronic device 100, the memory 120 may take the form of a hard disk drive or a flash memory. When the memory 120 is installed in a detachable form in the vehicle electronic device 100, the memory 120 may take the form of an SD card, a Micro SD card, or a USB memory. When the memory 120 is located externally to the vehicle electronic device 100, the memory 120 may exist in a storage space of another device or a database server through the communication unit 130.

The communication unit 130 is coupled operatively to the processor 110 and transmits and/or receives a radio signal. The communication unit 130 includes a transmitter and a receiver. The communication unit 130 may include a baseband circuit for processing a radio frequency signal. The communication unit 130 controls one or more antennas 131 to transmit and/or receive a radio signal. The communication unit 130 enables the vehicle electronic device 100 to communicate with other devices. Here, the communication unit 130 may be provided as a combination of at least one of various well-known communication modules, such as a cellular mobile communication module, a short-distance wireless communication module such as a wireless local area network (LAN) method, or a communication module using the low-power wide-area (LPWA) technique. Also, the communication unit 130 may perform a location-tracking function, such as the Global Positioning System (GPS) tracker.

The speaker 140 outputs a sound-related result processed by the processor 110. For example, the speaker 140 may output audio data indicating that a parking event has occurred. The microphone 141 receives sound-related input to be used by processor 110. The received sound, which is a sound caused by an external impact or a person's voice related to a situation inside/outside the vehicle, may help to recognize the situation at that time along with images captured by the image capture unit 116. The sound received through the microphone 141 may be stored in the memory 120.

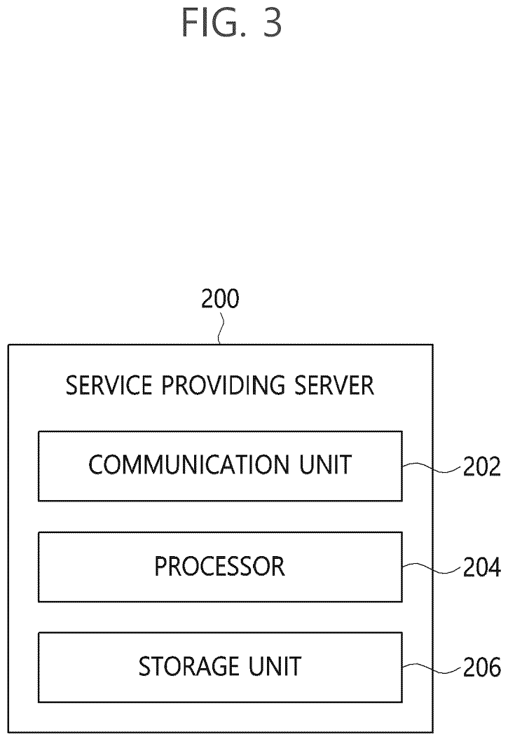

FIG. 3 is a block diagram illustrating a vehicle service providing server according to one embodiment.

Referring to FIG. 3, the vehicle service providing server 200 includes a communication unit 202, a processor 204, and a storage unit 206. The communication unit 202 of the vehicle service providing server 200 transmits and receives data to and from the vehicle electronic device 100 and/or the user terminal 300 through a wired/wireless communication network.

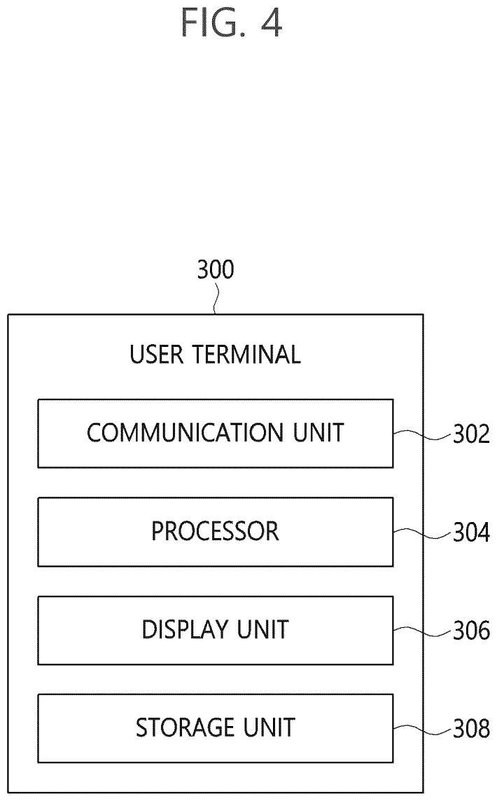

FIG. 4 is a block diagram of a user terminal according to one embodiment.

Referring to FIG. 4, the user terminal 300 includes a communication unit 302, a processor 304, a display unit 306, and a storage unit 308. The communication unit 302 transmits and receives data to and from the vehicle electronic device 100 and/or the vehicle service providing server 200 through a wired/wireless communication network. The processor 304 controls the overall function of the user terminal 300 and transmits a command input by the user to the vehicle service system 1000 through the communication unit 302 according to an embodiment of the present disclosure. When a control message related to a vehicle service is received from the vehicle service providing server 200, the processor 304 controls the display unit 306 to display the control message to the user.

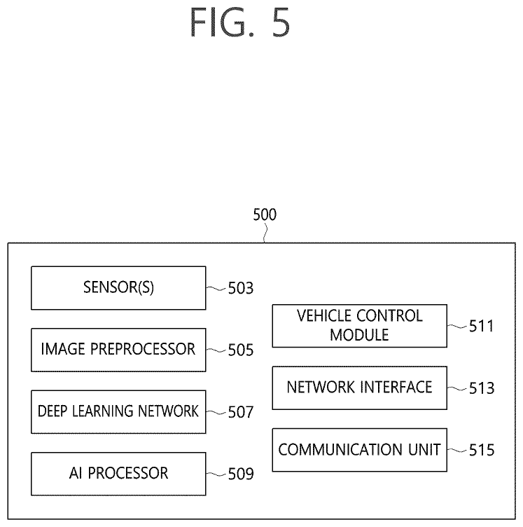

FIG. 5 is a block diagram illustrating an autonomous driving system 500 of a vehicle.

The autonomous driving system 500 of a vehicle according to FIG. 5 may be a deep learning network including sensors 503, an image preprocessor 505, a deep learning network 507, an artificial intelligence (AI) processor 509, a vehicle control module 511, a network interface 513, and a communication unit 515. In various embodiments, each constituting element may be connected through various interfaces. For example, sensor data sensed and output by the sensors 503 may be fed to the image preprocessor 505. The sensor data processed by the image preprocessor 505 may be fed to the deep learning network 507 that runs on the AI processor 509. The output of the deep learning network 507 run by the AI processor 509 may be fed to the vehicle control module 511. Intermediate results of the deep learning network 507 running on the AI processor 509 may be fed to the AI processor 509. In various embodiments, the network interface 513 transmits autonomous driving path information and/or autonomous driving control commands for the autonomous driving of the vehicle to internal block components by communicating with an electronic device in the vehicle. In one embodiment, the network interface 531 may be used to transmit sensor data obtained through sensor(s) 503 to an external server. In some embodiments, the autonomous driving control system 500 may include additional or fewer constituting elements, as deemed appropriate. For example, in some embodiments, the image preprocessor 505 may be an optional component. For another example, a post-processing component (not shown) may be included within the autonomous driving control system 500 to perform post-processing on the output of the deep learning network 507 before the output is provided to the vehicle control module 511.

In some embodiments, the sensors 503 may include one or more sensors. In various embodiments, the sensors 503 may be attached to different locations on the vehicle. The sensors 503 may face one or more different directions. For example, the sensors 503 may be attached to the front, sides, rear, and/or roof of a vehicle to face the forward-facing, rear-facing, and side-facing directions. In some embodiments, the sensors 503 may be image sensors such as high dynamic range cameras. In some embodiments, the sensors 503 include non-visual sensors. In some embodiments, the sensors 503 include a radar sensor, a light detection and ranging (LiDAR) sensor, and/or ultrasonic sensors in addition to the image sensor. In some embodiments, the sensors 503 are not mounted on a vehicle with the vehicle control module 511. For example, the sensors 503 may be included as part of a deep learning system for capturing sensor data, attached to the environment or road, and/or mounted to surrounding vehicles.

In some embodiments, the image preprocessor 505 may be used to preprocess sensor data of the sensors 503. For example, the image preprocessor 505 may be used to preprocess sensor data, split sensor data into one or more components, and/or postprocess one or more components. In some embodiments, the image preprocessor 505 may be a graphics processing unit (GPU), a central processing unit (CPU), an image signal processor, or a specialized image processor. In various embodiments, image preprocessor 505 may be a tone-mapper processor for processing high dynamic range data. In some embodiments, image preprocessor 505 may be a constituting element of AI processor 509.

In some embodiments, the deep learning network 507 may be a deep learning network for implementing control commands for controlling an autonomous vehicle. For example, the deep learning network 507 may be an artificial neural network such as a convolutional neural network (CNN) trained using sensor data, and the output of the deep learning network 507 is provided to the vehicle control module 511.

In various embodiments, the AI processor 509 may be coupled through an input/output interface to a memory configured to provide the AI processor with instructions to perform deep learning analysis on the sensor data received from the sensor(s) 503 while the AI processor 509 is running and to determine machine learning results used to make the vehicle operate with at least partial autonomy. In some embodiments, the vehicle control module 511 may be used to process commands for vehicle control output from the artificial intelligence (AI) processor 5509 and translate the output of the AI processor 509 into commands for controlling each vehicle module to control various vehicle modules. In some embodiments, the vehicle control module 511 is used to control a vehicle for autonomous driving. In some embodiments, the vehicle control module 511 may adjust the steering and/or speed of the vehicle. For example, the vehicle control module 511 may be used to control the driving of the vehicle, such as deceleration, acceleration, steering, lane change, and lane-keeping function. In some embodiments, the vehicle control module 511 may generate control signals to control vehicle lighting, such as brake lights, turn signals, and headlights. In some embodiments, the vehicle control module 511 may be used to control vehicle audio-related systems, such as the vehicle's sound system, audio warnings, microphone system, and horn system.

In some embodiments, the artificial intelligence (AI) processor 509 may be a hardware processor for running the deep learning network 507. In some embodiments, the AI processor 509 is a specialized AI processor for performing inference through a convolutional neural network (CNN) on sensor data. In some embodiments, the AI processor 509 may be optimized for bit depth of sensor data. In some embodiments, AI processor 509 may be optimized for deep learning computations, such as those of a neural network including convolution, inner product, vector and/or matrix operations. In some embodiments, the AI processor 509 may be implemented through a plurality of graphics processing units (GPUs) capable of effectively performing parallel processing.

In some embodiments, the vehicle control module 511 may be used to control notification systems that include warning systems to alert passengers and/or drivers of driving events, such as approaching an intended destination or potential collision. In some embodiments, the vehicle control module 511 may be used to calibrate sensors, such as the sensors 503 of the vehicle. For example, the vehicle control module 511 may modify the orientation of the sensors 503, change the output resolution and/or format type of the sensors 503, increase or decrease the capture rate, adjust the dynamic range, and adjust the focus of the camera. Also, the vehicle control module 511 may individually or collectively turn on or off the operation of the sensors.

In some embodiments, the vehicle control module 511 may be used to change the parameters of the image preprocessor 505, such as modifying the frequency range of filters, adjusting edge detection parameters for feature and/or object detection, and adjusting channels and bit depth. In various embodiments, the vehicle control module 511 may be used to control the autonomous driving and/or driver assistance functions of the vehicle.

In some embodiments, the network interface 513 may serve as an internal interface between block components of the autonomous driving control system 500 and the communication unit 515. Specifically, the network interface 513 may be a communication interface for receiving and/or sending data that includes voice data. In various embodiments, the network interface 513 may be connected to external servers to connect voice calls through the communication unit 515, receive and/or send text messages, transmit sensor data, update the software of the vehicle into the autonomous driving system, or update the software of the autonomous driving system of the vehicle.

In various embodiments, the communication unit 515 may include various cellular or WiFi-type wireless interfaces. For example, the network interface 513 may be used to receive updates on operating parameters and/or instructions for the sensors 503, image preprocessor 505, deep learning network 507, AI processor 509, and vehicle control module 511 from an external server connected through the communication unit 515. For example, a machine learning model of the deep learning network 507 may be updated using the communication unit 515. According to another example, the communication unit 515 may be used to update the operating parameters of the image preprocessor 505 such as image processing parameters and/or the firmware of the sensors 503.

In another embodiment, the communication unit 515 may be used to activate communication for emergency services and emergency contact in an accident or near-accident event. For example, in the event of a collision, the communication unit 515 may be used to call emergency services for assistance and may be used to inform emergency services of the collision details and the vehicle location. In various embodiments, the communication unit 515 may update or obtain an expected arrival time and/or the location of a destination.

According to one embodiment, the autonomous driving system 500 shown in FIG. 5 may be configured as a vehicle electronic device. According to one embodiment, when the user triggers an autonomous driving release event during autonomous driving of the vehicle, the AI processor 509 of the autonomous driving system 500 may train the autonomous driving software of the vehicle by controlling the information related to the autonomous driving release event to be input as the training set data of a deep learning network.

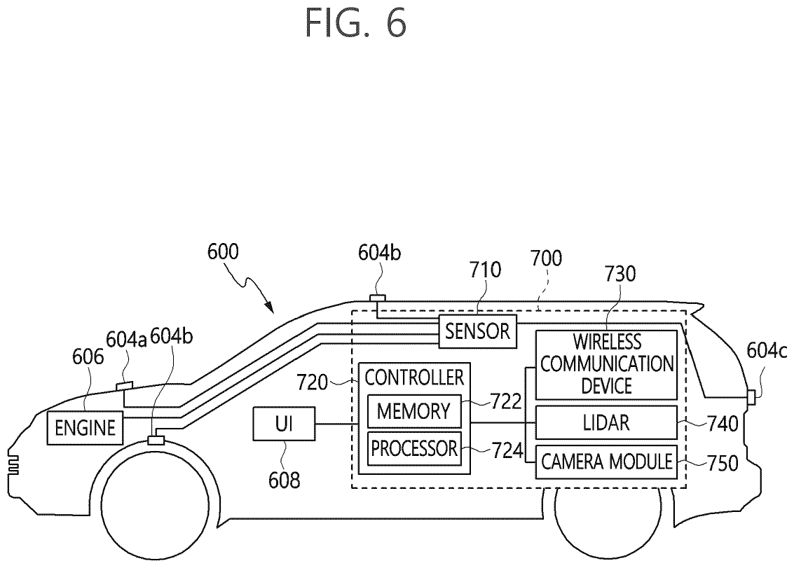

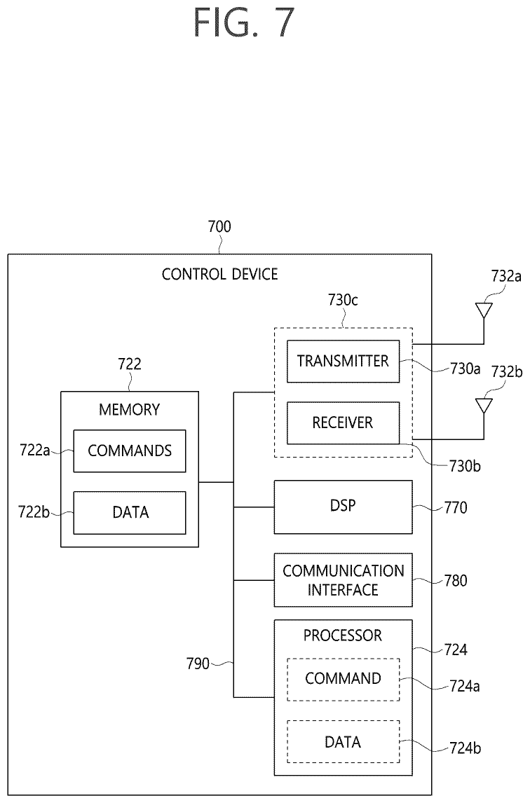

FIGS. 6 and 7 are one example of a block diagram illustrating an autonomous driving moving body according to one embodiment. Referring to FIG. 6, the autonomous driving moving body 600 according to the present embodiment may include a control device 700, sensing modules 604a, 604b, 604c, 604d, an engine 606, and a user interface 608.

The autonomous driving moving body 600 may have an autonomous driving mode or a manual mode. For example, the manual mode may be switched to the autonomous driving mode, or the autonomous driving mode may be switched to the manual mode according to the user input received through the user interface 608.

When the autonomous driving moving body 600 is operated in the autonomous driving mode, the autonomous driving moving body 600 may be operated under the control of the control device 700.

In the present embodiment, the control device 700 may include a controller 720 that includes a memory 722 and a processor 724, a sensor 710, a communication device 730, and an object detection device 740.

Here, the object detection device 740 may perform all or part of the functions of the distance measuring device (e.g., the electronic device 71).

In other words, in the present embodiment, the object detection device 740 is a device for detecting an object located outside the moving body 600, and the object detection device 740 may detect an object located outside the moving body 600 and generate object information according to the detection result.

The object information may include information on the presence or absence of an object, location information of the object, distance information between the moving body and the object, and relative speed information between the moving body and the object.

The objects may include various objects located outside the moving body 600, such as lanes, other vehicles, pedestrians, traffic signals, lights, roads, structures, speed bumps, terrain objects, and animals. Here, the traffic signal may include a traffic light, a traffic sign, and a pattern or text drawn on a road surface. Also, the light may be light generated from a lamp installed in another vehicle, light generated from a street lamp, or sunlight.

Also, the structures may be an object located near the road and fixed to the ground. For example, the structures may include street lights, street trees, buildings, telephone poles, traffic lights, and bridges. The terrain objects may include a mountain, a hill, and the like.

The object detection device 740 may include a camera module. The controller 720 may extract object information from an external image captured by the camera module and process the extracted information.

Also, the object detection device 740 may further include imaging devices for recognizing an external environment. In addition to the LiDAR sensors, radar sensors, GPS devices, odometry and other computer vision devices, ultrasonic sensors, and infrared sensors may be used, and these devices may be selected as needed or operated simultaneously to enable more precise sensing.

Meanwhile, the distance measuring device according to one embodiment of the present disclosure may calculate the distance between the autonomous driving moving body 600 and an object and control the operation of the moving body based on the calculated distance in conjunction with the control device 700 of the autonomous driving moving body 600.

For example, suppose a collision may occur depending on the distance between the autonomous driving moving body 600 and an object. In that case, the autonomous driving moving body 600 may control the brake to slow down or stop. As another example, if the object is a moving object, the autonomous driving moving body 600 may control the driving speed of the autonomous driving moving body 600 to keep a distance larger than a predetermined threshold from the object.

The distance measuring device according to one embodiment of the present disclosure may be configured as one module within the control device 700 of the autonomous driving moving body 600. In other words, the memory 722 and the processor 724 of the control device 700 may implement a collision avoidance method according to the present disclosure in software.

Also, the sensor 710 may obtain various types of sensing information from the internal/external environment of the moving body by being connected to the sensing modules 604a, 604b, 604c, and 604d. Here, the sensor 710 may include a posture sensor (e.g., a yaw sensor, a roll sensor, or a pitch sensor), a collision sensor, a wheel sensor, a speed sensor, an inclination sensor, a weight sensor, a heading sensor, a gyro sensor, a location module, a sensor measuring the forward/backward movement of the moving body, a battery sensor, a fuel sensor, a tire sensor, a steering sensor measuring the rotation of the steering wheel, a sensor measuring the internal temperature of the moving body, and a sensor measuring the internal humidity of the moving body, an ultrasonic sensor, an illumination sensor, an accelerator pedal location sensor, and a brake pedal location sensor.

Accordingly, the sensor 710 may obtain sensing signals related to moving body attitude information, moving body collision information, moving body direction information, moving body location information (GPS information), moving body orientation information, moving body speed information, moving body acceleration information, moving body tilt information, moving body forward/backward movement information, battery information, fuel information, tire information, moving body lamp information, moving body internal temperature information, moving body internal humidity information, steering wheel rotation angle, external illuminance of the moving body, pressure applied to the accelerator pedal, and pressure applied to the brake pedal.

Also, the sensor 710 may further include an accelerator pedal sensor, a pressure sensor, an engine speed sensor, an air flow sensor (AFS), an intake air temperature sensor (ATS), a water temperature sensor (WTS), a throttle location sensor (TPS), a TDC sensor, and a crank angle sensor (CAS).

As described above, the sensor 710 may generate moving object state information based on the sensing data.

The wireless communication device 730 is configured to implement wireless communication between autonomous driving moving bodies 600. For example, the wireless communication device 730 enables the autonomous driving moving body 600 to communicate with a user's mobile phone, another wireless communication device 730, another moving body, a central device (traffic control device), or a server. The wireless communication device 730 may transmit and receive wireless signals according to a wireless communication protocol. The wireless communication protocol may be Wi-Fi, Bluetooth, Long-Term Evolution (LTE), Code Division Multiple Access (CDMA), Wideband Code Division Multiple Access (WCDMA), or Global Systems for Mobile Communications (GSM); however, the communication protocol is not limited to the specific examples above.

Also, the autonomous driving moving body 600 according to the present embodiment may implement communication between mobile bodies through the wireless communication device 730. In other words, the wireless communication device 730 may communicate with other moving bodies on the road through vehicle-to-vehicle communication. The autonomous driving moving body 600 may transmit and receive information such as a driving warning and traffic information through vehicle-to-vehicle communication and may also request information from another moving body or receive a request from another moving body. For example, the wireless communication device 730 may perform V2V communication using a dedicated short-range communication (DSRC) device or a Cellular-V2V (C-V2V) device. In addition to the V2V communication, communication between a vehicle and other objects (e.g., electronic devices carried by pedestrians) (Vehicle to Everything (V2X) communication) may also be implemented through the wireless communication device 730.

In the present embodiment, the controller 720 is a unit that controls the overall operation of each unit within the moving body 600, which may be configured by the manufacturer of the moving body at the time of manufacturing or additionally configured to perform the function of autonomous driving after manufacturing. Alternatively, the controller may include a configuration for the continuing execution of additional functions through an upgrade of the controller 720 configured at the time of manufacturing. The controller 720 may be referred to as an Electronic Control Unit (ECU).

The controller 720 may collect various data from the connected sensor 710, the object detection device 740, the communication device 730, and so on and transmit a control signal to the sensor 710, the engine 606, the user interface 608, the communication device 730, and the object detection device 740 including other configurations within the moving body. Also, although not shown in the figure, the control signal may be transmitted to an accelerator, a braking system, a steering device, or a navigation device related to the driving of the moving body.

In the present embodiment, the controller 720 may control the engine 606; for example, the controller 720 may detect the speed limit of the road on which the autonomous driving moving body 600 is driving and control the engine to prevent the driving speed from exceeding the speed limit or control the engine 606 to accelerate the driving speed of the autonomous driving moving body 600 within a range not exceeding the speed limit.

Also, if the autonomous driving moving body 600 is approaching or departing from the lane while the autonomous driving moving body 600 is driving, the controller 720 may determine whether the approaching or departing from the lane is due to a normal driving situation or other unexpected driving situations and control the engine 606 to control the driving of the moving body according to the determination result. Specifically, the autonomous driving moving body 600 may detect lanes formed on both sides of the road in which the moving body is driving. In this case, the controller 720 may determine whether the autonomous driving moving body 600 is approaching or leaving the lane; if it is determined that the autonomous driving moving body 600 is approaching or departing from the lane, the controller 720 may determine whether the driving is due to a normal driving situation or other driving situations. Here, as an example of a normal driving situation, the moving body may need to change lanes. Similarly, as an example of other driving situations, the moving body may not need a lane change. If the controller 720 determines that the autonomous driving moving body 600 is approaching or departing from the lane in a situation where a lane change is not required for the moving body, the controller 720 may control the driving of the autonomous driving moving body 600 so that the autonomous driving moving body 600 does not leave the lane and keeps normal driving.

When encountering another moving body or an obstacle in front of the moving body, the controller 720 may control the engine 606 or the braking system to decelerate the autonomous driving moving body and control the trajectory, driving path, and steering angle in addition to speed. Alternatively, the controller 720 may control the driving of the moving body by generating necessary control signals according to the recognition information of other external environments, such as driving lanes and driving signals of the moving body.

In addition to generating a control signal for the moving body, the controller 720 may also control the driving of the moving body by communicating with surrounding moving bodies or a central server and transmitting commands to control the peripheral devices through the received information.

Also, when the location of the camera module 750 is changed, or the angle of view is changed, it may be difficult for the controller 720 to accurately recognize a moving object or a lane according to the present embodiment; to address the issue above, the controller 750 may generate a control signal, which controls the camera module 750 to perform calibration. Therefore, since the controller 720 according to the present embodiment generates a control signal for the calibration of the camera module 750, the normal mounting location, orientation, and angle of view of the camera module 750 may be kept continuously even if the mounting location of the camera module 750 is changed due to vibration or shock generated by the motion of the autonomous driving moving body 600. The controller 720 may generate a control signal to perform calibration of the camera module 720 when the initial mounting location, orientation, and angle of view information of the camera module 720 stored in advance deviate from the initial mounting location, orientation, and angle of view information of the camera module 720 measured while the autonomous driving moving body 600 is driving by more than a threshold value.

In the present embodiment, the controller 720 may include the memory 722 and the processor 724. The processor 724 may execute the software stored in the memory 722 according to the control signal of the controller 720. Specifically, the controller 720 may store data and commands for performing a lane detection method according to the present disclosure in the memory 722, and the commands may be executed by the processor 724 to implement one or more methods of the present disclosure.

At this time, the memory 722 may be implemented by a non-volatile recording medium executable by the processor 724. The memory 722 may store software and data through an appropriate internal or external device. The memory 722 may be configured to include a random-access memory (RAM), a read only memory (ROM), a hard disk, and a memory 722 device coupled with a dongle.

The memory 722 may store at least an operating system (OS), a user application, and executable commands. The memory 722 may also store application data and array data structures.

The processor 724 may be a microprocessor or an appropriate electronic processor, which may be a controller, a microcontroller, or a state machine.

The processor 724 may be implemented as a combination of computing devices, and the computing device may be a digital signal processor, a microprocessor, or an appropriate combination thereof.

Meanwhile, the autonomous driving moving body 600 may further include a user interface 608 for receiving a user's input to the control device 700 described above. The user interface 608 may allow the user to enter information through an appropriate interaction. For example, the user interface 608 may be implemented as a touch screen, a keypad, or a set of operation buttons. The user interface 608 may transmit an input or a command to the controller 720, and the controller 720 may perform a control operation of the moving object in response to the input or command.

Also, the user interface 608 may allow a device external to the autonomous driving moving body 600 to communicate with the autonomous driving moving body 600 through the wireless communication device 730. For example, the user interface 608 may be compatible with a mobile phone, a tablet, or other computing devices.

Furthermore, although the present embodiment assumes that the autonomous driving moving body 600 is configured to include the engine 606, it is also possible to include other types of propulsion systems. For example, the moving body may be operated by electric energy, hydrogen energy, or a hybrid system combining them. Therefore, the controller 720 may include a propulsion mechanism according to the propulsion system of the autonomous driving moving body 600 and provide a control signal according to the propulsion mechanism to the components of each propulsion mechanism.

In what follows, a specific structure of the control device 700 according to an embodiment of the present disclosure will be described in more detail with reference to FIG. 7.

The control device 700 includes a processor 724. The processor 724 may be a general-purpose single or multi-chip microprocessor, a dedicated microprocessor, a micro-controller, or a programmable gate array. The processor may be referred to as a central processing unit (CPU). Also, the processor 724 according to the present disclosure may be implemented by a combination of a plurality of processors.

The control device 700 also includes a memory 722. The memory 722 may be an arbitrary electronic component capable of storing electronic information. The memory 722 may also include a combination of memories 722 in addition to a single memory.

The memory 722 may store data and commands 722a for performing a distance measuring method by a distance measuring device according to the present disclosure. When the processor 724 performs the commands 722a, the commands 722a and the whole or part of the data 722b needed to perform the commands may be loaded into the processor 724.

The control device 700 may include a transmitter 730a, a receiver 730b, or a transceiver 730c for allowing transmission and reception of signals. One or more antennas 732a, 732b may be electrically connected to the transmitter 730a, receiver 730b, or each transceiver 730c and may additionally include antennas.

The control device 700 may include a digital signal processor (DSP) 770. Through the DSP 770, the moving body may quickly process digital signals.

The control device 700 may include a communication interface 780. The communication interface 780 may include one or more ports and/or communication modules for connecting other devices to the control device 700. The communication interface 780 may allow a user and the control device 700 to interact with each other.

Various components of the control device 700 may be connected together by one or more buses 790, and the buses 790 may include a power bus, a control signal bus, a status signal bus, a data bus, and the like. Under the control of the processor 724, components may transfer information to each other through the bus 790 and perform target functions.

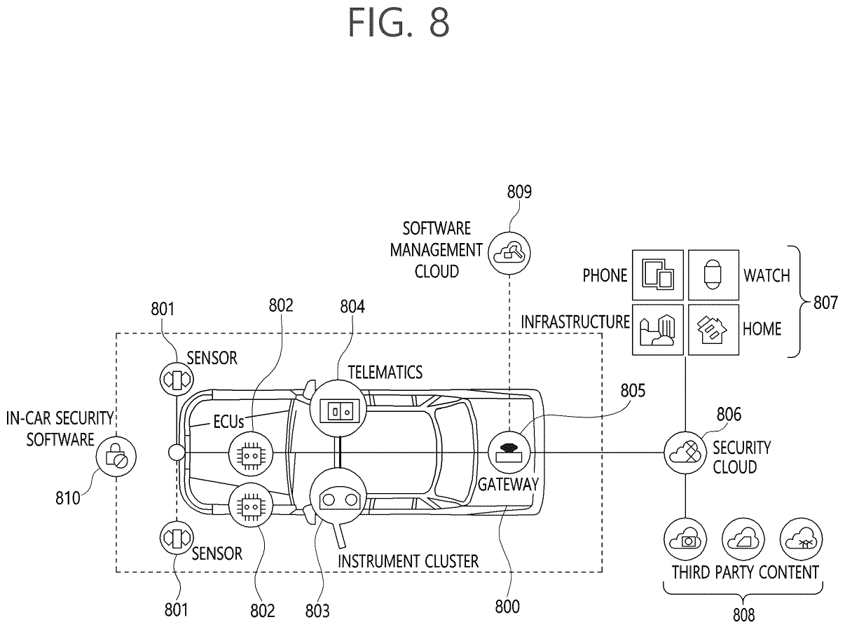

Meanwhile, in various embodiments, the control device 700 may be associated with a gateway for communication with a security cloud. For example, referring to FIG. 8, the control device 700 may be related to a gateway 805 for providing information obtained from at least one of the components 801 to 804 of the vehicle 800 to the security cloud 806. For example, the gateway 805 may be included in the control device 700. In another example, the gateway 805 may be configured as a separate device within the vehicle 800 distinguished from the control device 700. The gateway 805 communicatively connects the software management cloud 809 having different networks, the security cloud 806, and the network within the vehicle 800 secured by the in-vehicle security software 810.

For example, the constituting element 801 may be a sensor. For example, the sensor may be used to obtain information on at least one of the state of the vehicle 800 and the state of the surroundings of the vehicle 800. For example, the constituting element 801 may include the sensor 1410.

For example, the constituting element 802 may be electronic control units (ECUs). For example, the ECUs may be used for engine control, transmission control, airbag control, and management of tire air pressure management.

For example, the constituting element 803 may be an instrument cluster. For example, the instrument cluster may refer to a panel located in front of a driver's seat in the dashboard. For example, the instrument cluster may be configured to show information necessary for driving to the driver (or passengers). For example, the instrument cluster may be used to display at least one of the visual elements for indicating revolutions per minute or rotate per minute (RPM) of the engine, visual elements for indicating the speed of the vehicle 800, visual elements for indicating the remaining fuel amount, visual elements for indicating the state of the gear, or visual elements for indicating information obtained through the constituting element 801.

For example, the constituting element 804 may be a telematics device. For example, the telematics device may refer to a device that provides various mobile communication services such as location information and safe driving within the vehicle 800 by combining wireless communication technology and global positioning system (GPS) technology. For example, the telematics device may be used to connect the vehicle 800 with the driver, the cloud (e.g., the security cloud 806), and/or the surrounding environment. For example, the telematics device may be configured to support high bandwidth and low latency to implement the 5G NR standard technology (e.g., V2X technology of 5G NR). For example, the telematics device may be configured to support autonomous driving of the vehicle 800.

For example, the gateway 805 may be used to connect a software management cloud 809 and the security cloud 806, which are a network inside the vehicle 800 and a network outside the vehicle. For example, the software management cloud 809 may be used to update or manage at least one software necessary for driving and managing the vehicle 800. For example, the software management cloud 809 may be linked with in-car security software 810 installed within the vehicle. For example, the in-car security software 810 may be used to provide the security function within the vehicle 800. For example, the in-car security software 810 may encrypt data transmitted and received through the in-car network using an encryption key obtained from an external authorized server to encrypt the in-vehicle network. In various embodiments, the encryption key used by the in-car security software 810 may be generated in response to the vehicle identification information (license plate or vehicle identification number (VIN)) or information uniquely assigned to each user (e.g., user identification information).

In various embodiments, the gateway 805 may transmit data encrypted by the in-car security software 810 based on the encryption key to the software management cloud 809 and/or the security cloud 806. The software management cloud 809 and/or the security cloud 806 may identify from which vehicle or which user the data has been received by decrypting encrypted data using a decryption key capable of decrypting the data encrypted by the encryption key of the in-vehicle security software 810. For example, since the decryption key is a unique key corresponding to the encryption key, the software management cloud 809 and/or the security cloud 806 may identify the transmitter of the data (e.g., the vehicle or the user) based on the data decrypted through the decryption key.

For example, the gateway 805 may be configured to support in-car security software 810 and may be associated with the control device 700. For example, the gateway 805 may be associated with the control device 700 to support a connection between the control device 700 and a client device 807 connected to the security cloud 806. In another example, the gateway 805 may be associated with the control device 700 to support a connection between the control device 700 and the third-party cloud 808 connected to the security cloud 806. However, the present disclosure is not limited to the specific description above.

In various embodiments, the gateway 805 may be used to connect the vehicle 800 with a software management cloud 809 for managing the operating software of the vehicle 800. For example, the software management cloud 809 may monitor whether an update of the operating software of the vehicle 800 is required and provide data for updating the operating software of the vehicle 800 through the gateway 805 based on the monitoring that an update of the operating software of the vehicle 800 is required. In another example, the software management cloud 809 may receive a user request requesting an update of the operating software of the vehicle 800 from the vehicle 800 through the gateway 805 and provide data for updating the operating software of the vehicle 800 based on the received user request. However, the present disclosure is not limited to the specific description above.

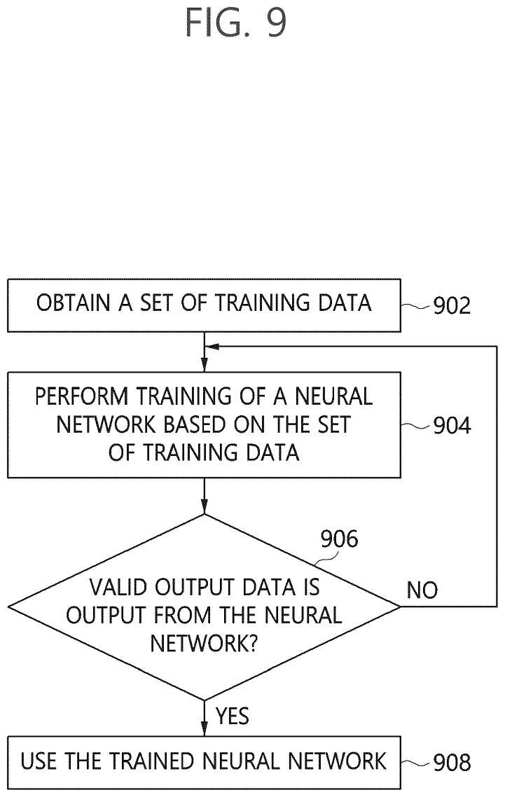

FIG. 9 illustrates the operation of an electronic device 101 training a neural network based on a training dataset according to one embodiment.

Referring to FIG. 9, in the step 902, the electronic device according to one embodiment may obtain a training dataset. The electronic device may obtain a set of training data for supervised learning. The training data may include a pair of input data and ground truth data corresponding to the input data. The ground truth data may represent output data to be obtained from a neural network that has received input data that is a pair of the ground truth data.

For example, when a neural network is trained to recognize an image, training data may include images and information on one or more subjects included in the images. The information may include a category or class of a subject identifiable through an image. The information may include the location, width, height, and/or size of a visual object corresponding to the subject in the image. The set of training data identified through the operation of step 902 may include a plurality of training data pairs. In the above example of training a neural network for image recognition, the set of training data identified by the electronic device may include a plurality of images and ground truth data corresponding to each of the plurality of images.

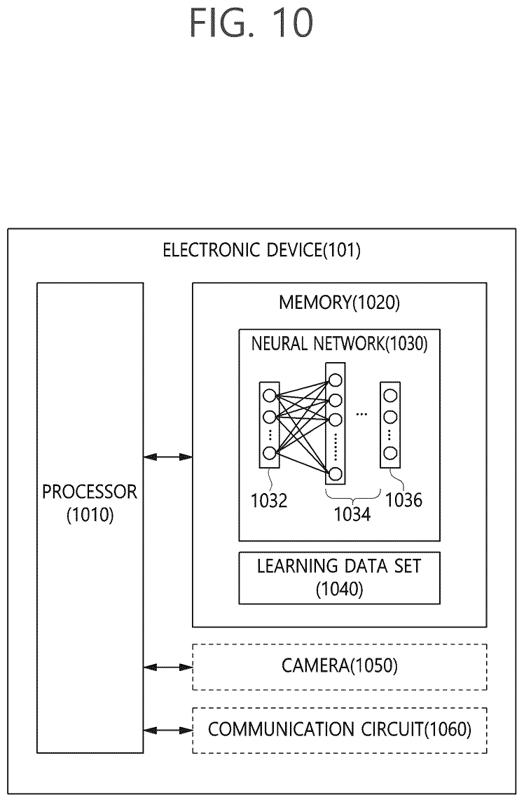

Referring to FIG. 9, in the step 904, the electronic device according to one embodiment may perform training on a neural network based on a set of training data. In one embodiment in which the neural network is trained based on supervised learning, the electronic device may provide input data included in the training data to an input layer of the neural network. An example of a neural network including the input layer will be described with reference to FIG. 10. From the output layer of the neural network that has received the input data through the input layer, the electronic device may obtain output data of the neural network corresponding to the input data.

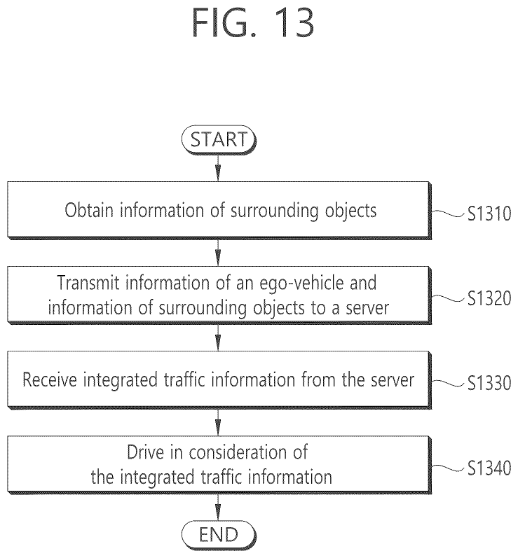

In one embodiment, the training in the step 904 may be performed based on a difference between the output data and the ground truth data included in the training data and corresponding to the input data. For example, the electronic device may adjust one or more parameters (e.g., weights described later with reference to FIG. 13) related to the neural network to reduce the difference based on the gradient descent algorithm. The operation of the electronic device that adjusts one or more parameters may be referred to as the tuning of the neural network. The electronic device may perform tuning of the neural network based on the output data using a function defined to evaluate the performance of the neural network, such as a cost function. A difference between the output and ground truth data may be included as one example of the cost function.

Referring to FIG. 9, in the step 906, the electronic device according to one embodiment may identify whether valid output data is output from the neural network trained in the step 904. That the output data is valid may mean that a difference (or a cost function) between the output and ground truth data satisfies a condition set to use the neural network. For example, when the average value and/or the maximum value of the differences between the output and ground truth data is less than or equal to a predetermined threshold value, the electronic device may determine that valid output data is output from the neural network.

When valid output data is not output from the neural network (No in the step 906), the electronic device may repeatedly perform training of the neural network based on the operation of the step 904. The embodiment is not limited to the specific description, and the electronic device may repeatedly perform the operations of steps 902 and 904.

When valid output data is obtained from the neural network (Yes in the step 906), the electronic device according to one embodiment may use the trained neural network based on the operation of the step 908. For example, the electronic device may provide input data different from those supplied to the neural network as training data. The electronic device may use the output data obtained from the neural network that has received the different input data as a result of performing inference on the different input data based on the neural network.

FIG. 10 is a block diagram of an electronic device 101 according to one embodiment.

Referring to FIG. 10, the processor 1010 of the electronic device 101 may perform computations related to the neural network 1030 stored in the memory 1020. The processor 1010 may include at least one of a center processing unit (CPU), a graphic processing unit (GPU), or a neural processing unit (NPU). The NPU may be implemented as a chip separate from the CPU or integrated into the same chip as the CPU in the form of a system on a chip (SoC). The NPU integrated into the CPU may be referred to as a neural core and/or an artificial intelligence (AI) accelerator.

Referring to FIG. 10, the processor 1010 may identify the neural network 1030 stored in the memory 1020. The neural network 1030 may include a combination of an input layer 1032, one or more hidden layers 1034 (or intermediate layers), and output layers 1036. The layers above (e.g., the input layer 1032, one or more hidden layers 1034, and the output layer 1036) may include a plurality of nodes. The number of hidden layers 1034 may vary depending on embodiments, and the neural network 1030 including a plurality of hidden layers 1034 may be referred to as a deep neural network. The operation of training the deep neural network may be referred to as deep learning.

In one embodiment, when the neural network 1030 has a structure of a feed-forward neural network, a first node included in a specific layer may be connected to all of the second nodes included in a different layer before the specific layer. In the memory 1020, parameters stored for the neural network 1030 may include weights assigned to the connections between the second nodes and the first node. In the neural network 1030 having the structure of a feed-forward neural network, the value of the first node may correspond to a weighted sum of values assigned to the second nodes, which is based on weights assigned to the connections connecting the second nodes and the first node.

In one embodiment, when the neural network 1030 has a convolutional neural network structure, a first node included in a specific layer may correspond to a weighted sum of part of the second nodes included in a different layer before the specific layer. Part of the second nodes corresponding to the first node may be identified by a filter corresponding to the specific layer. Parameters stored for the neural network 1030 in the memory 1020 may include weights representing the filter. The filter may include, among the second nodes, one or more nodes to be used to compute the weighted sum of the first node and weights corresponding to each of the one or more nodes.

The processor 1010 of the electronic device 101 according to one embodiment may perform training on the neural network 1030 using the training dataset 1040 stored in the memory 1020. Based on training data set 1040, the processor 1010 may adjust one or more parameters stored in memory 1020 for the neural network 1030 by performing the operations described with reference to FIG. 9.

The processor 1010 of the electronic device 101 according to one embodiment may use the neural network 1030 trained based on the training data set 1040 to perform object detection, object recognition, and/or object classification. The processor 1010 may input images (or video) captured through the camera 1050 to the input layer 1032 of the neural network 1030. Based on the input layer 1032 which has received the images, the processor 1010 may sequentially obtain the values of nodes of the layers included in the neural network 1030 and obtain a set of values of nodes of the output layer 1036 (e.g., output data). The output data may be used as a result of inferring information included in the images using the neural network 1030. The embodiment is not limited to the specific description above, and the processor 1010 may input images (or video) captured from an external electronic device connected to the electronic device 101 through the communication circuit 1060 to the neural network 1030.

In one embodiment, the neural network 1030 trained to process an image may be used to identify a region corresponding to a subject in the image (object detection) and/or the class of the subject expressed in the image (object recognition and/or object classification). For example, the electronic device 101 may use the neural network 1030 to segment a region corresponding to the subject within the image based on a rectangular shape such as a bounding box. For example, the electronic device 101 may use the neural network 1030 to identify at least one class matching the subject from among a plurality of designated classes.

The following embodiments may be implemented using devices or constituting elements of the devices of FIGS. 1 to 10 and functions, methods, and procedures described in FIGS. 1 to 10.

Recently, as black boxes are widely used, various products utilizing image information, such as Advanced Driver Assistance Systems (ADAS) functions and AI-based parking recording along with the original function of storing camera images and vehicle driving information are released. Also, the black box, traditionally available as an after-market product, is now being installed as a genuine function of the car; accordingly, the importance of the black box is rising, and ongoing research is exploring methods to utilize the camera provided in the black box.

In particular, with the advent of electric vehicles and autonomous driving vehicles, since the vehicle power problem is being addressed and the trend of integrating multiple camera sensors required for autonomous driving is widely adopted, there is a growing demand to use the black box, not just as a simple storage device but as a means of implementing autonomous driving.

In vehicle driving, an image acquisition device using a camera is now used as a basic function of a vehicle, such as the smart cruise function for recognizing a distant subject while driving, adjusting the vehicle's speed, recognizing a lane, and operating a lane-keeping device. Also, the technique for recognizing pedestrians in the front of the vehicle and recognizing an object in the rear/side space of the vehicle using cameras with a wide angle of view allows faster and more accurate recognition of subjects within a short distance of the vehicle.

As described above, the cameras necessitated for autonomous driving at level 2 are evolving into the form of an integrated controller for vehicle driving in autonomous driving at level 3 or higher; the black box is essential for the integration process and needs to provide functions that do not overlap with vehicle ADAS cameras. Accordingly, image information obtained from multiple cameras including the black box and information obtained from other sensors (e.g., a radar sensor or a LiDAR sensor) need to be integrated for vehicle operation and used for transmission/reception of V2X information required for autonomous driving.

Information obtained from many vehicles is transmitted through a high-speed communication network; when the information is shared, it is expected that the V2X technology, essential for achieving autonomous driving at level 4, may become attainable. However, there needs to be a specific means to collect and use the information required for V2X. In particular, to figure out the driving environment for autonomous driving, data from eight or more cameras, radar, lidar, and ultrasonic sensors inside a vehicle are typically required; after the data obtained from these sensors are used for object recognition, judgment, and control for driving, most of the data is discarded.

Therefore, the present embodiment proposes a method for generating a database required for autonomous driving by integrating data obtained from various sensors within the vehicle and processing the data.

In one embodiment, a proposed method generates relative coordinates from a driving location of a vehicle for an object recognized through a camera of the black box and a sensor such as the radar/LiDAR sensor within the corresponding vehicle and transmits the generated data to a server, after which the server generates absolute coordinates of the respective objects by aggregating the data received from individual vehicles and processes the data in conjunction with a cooperative-intelligent transport system (C-ITS) for the situation on the entire road.

The main concept of the present embodiment lies in that each vehicle on the road obtains relative coordinates of an external vehicle through a camera of a black box and a sensor such as the radar/LiDAR sensor and transmits the obtained relative coordinates of the external vehicle and absolute coordinates of the ego-vehicle to a server (or a traffic information center), and the server generates absolute coordinates of the vehicles on the road by using absolute coordinates of each vehicle obtained from the respective vehicles and relative coordinates of external vehicles. In particular, the absolute coordinates of non-communicating vehicles incapable of communicating with the server may be generated by combining the relative coordinates of the non-communicating vehicles recognized by communicating vehicles.

Also, in one embodiment, a unique identifier is generated for a vehicle whose vehicle number has been recognized, absolute coordinates are generated for a vehicle to which the unique identifier has been assigned, and errors that may occur due to duplicate vehicle numbers are thereby prevented. One embodiment will be described below based on the basic concept of the present embodiment described above.

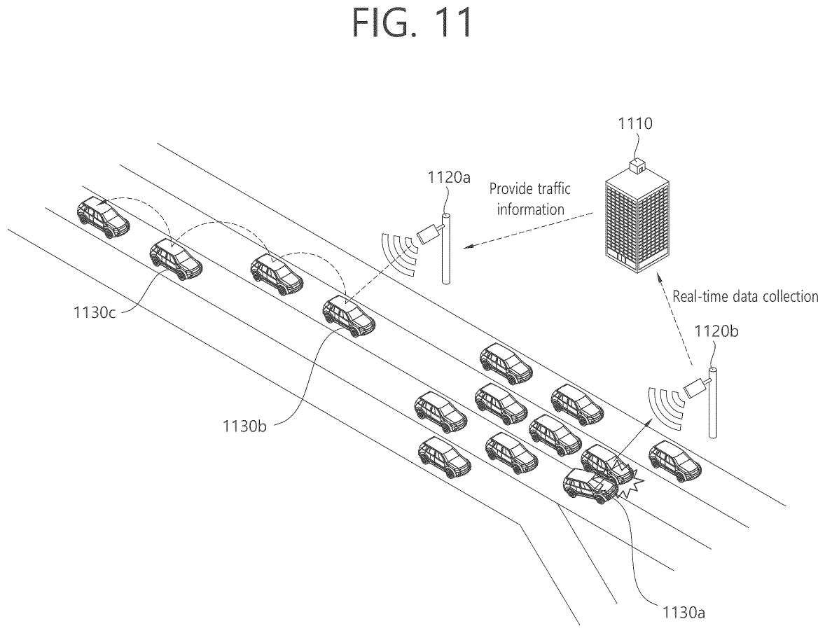

FIG. 11 illustrates one example of an intelligent transport system according to one

embodiment.

Referring to FIG. 11, an intelligent transport system includes a traffic information center 1110, road side units (RSUs) 1120a, 1120b, and vehicles on the road 1130a, 1130b, 1130c. The traffic information center 1110 may serve as a server that integrates and manages data received from vehicles. Therefore, the traffic information center may be referred to as a ‘server.’ The Road Side Unit (RSU) 1120a, 1120b is an infrastructure device capable of wirelessly communicating with vehicles and performing wired/wireless communication with the server 1110; the RSU may serve as a base station or a relay station, the form of which is not limited to a specific constraint.

The vehicles 1130a, 1130b, 1130c may detect a surrounding object which affects the driving of the vehicles 1130a, 1130b, 1130c such as other vehicles, road, traffic lights, signs, or pedestrians, using a camera and a radar/LiDAR sensor and may obtain information on the detected surrounding object. The information on the surrounding object may include relative coordinates based on the ego-vehicle. Also, the information on the surrounding object may include information on which the ego-vehicle can identify. For example, when the surrounding object is a vehicle, the information on the surrounding object may include an object identifier indicating the detected surrounding object is a vehicle and license plate information on the vehicle.

In FIG. 11, it is explained that the ego-vehicle driving on the road transmits only the identification information of surrounding vehicles located around the ego-vehicle and the location of the surrounding vehicles as relative coordinate information to the server 1110. However, this is only for convenience of explanation, and identification information about other objects that affect the passage of the ego-vehicle and information on the relative locations of those objects can also be transmitted to the server 1110.

Referring to FIG. 11, in one embodiment, it is desirable that the server 1110 sets the location information of the RSUs 1120a and 1120b pre-installed around the road as absolute locations in order to easily measure the relative location information of vehicles driving on the road. The location of the vehicle traveling on the road continues to change with the passage of time, but the locations of the RSUs 1120a and 1120b are fixed. Therefore, it is possible that the server 1110 obtains location information of the RSUs 1120a and 1120b located on the road in advance, checks the relative locations of the vehicles (1130a, 1130b, 1130c, etc.) from the corresponding RSUs (1120a, 1120b), and track the locations of the vehicles (1130a, 1130b, 1130c, etc.) over time.

The vehicles 1130a, 1130b, 1130c may transmit the information of their ego-vehicle together with the information of the detected surrounding object to the server 1110 through the RSU 1120a, 1120b. The ego-vehicle information may include, for example, the absolute coordinates of the ego-vehicle. The absolute coordinates may be the latitude and longitude information of the ego-vehicle based on GPS information. The information of the ego-vehicle may include license plate information of the ego-vehicle. Typically, the ego-vehicle information is not stored in the vehicle; however, in one embodiment, the vehicle number information of the ego-vehicle may be pre-stored in the vehicle and transmitted to the server 1110. Also, the information on the ego-vehicle may include driving information related to the destination, direction, and speed of the vehicle, such as navigation information of the ego-vehicle; the information may include information on the vehicle type or vehicle model.

The server 1110 may receive information on the ego-vehicle and information on surrounding objects from each of the vehicles 1130a, 1130b, 1130c and generate integrated traffic information using the received information. The integrated traffic information may include information on conditions of external vehicles, pedestrians, traffic lights, road construction, and accidents. The integrated traffic information may be referred to as ‘integrated traffic object information’ or ‘integrated object information.’ In what follows, the term ‘integrated object information’ will be used to emphasize the information of vehicles on the road.

In one example of generating the integrated object information, the server 1110 may generate unique identifiers of individual vehicles 1130a, 1130b, 1130c by using the license plate information of objects (i.e., vehicles) received from the respective vehicles 1130a, 1130b, 1130c. Also, the server 1110 may determine the absolute coordinates of the vehicles on the road using the absolute coordinates and the relative coordinates of the objects (i.e., vehicles) received from the individual vehicles 1130a, 1130b, 1130c.

In other words, the server 1110 may generate a unique identifier for a vehicle for which the vehicle number has been identified by integrating the vehicle number information of the ego-vehicles and vehicle number information of external vehicles received from the individual vehicles 1130a, 1130b, 1130c. Also, the absolute coordinates of the vehicle may be generated based on the absolute coordinates included in the information of the ego-vehicles and/or the relative coordinates of surrounding objects included in the information of the surrounding objects transmitted by the individual vehicles 1130a, 1130b, 1130c. Among the vehicles on the road, some vehicles may communicate with the server 1110 and transmit their absolute coordinates, while others are unable to communicate with the server 1110. The absolute coordinates of the vehicle, which is unable to communicate with the server 1110, may be derived by combining the relative coordinates of surrounding objects recognized by other vehicles capable of communicating with the server 1110.

For instance, the universally unique identifier (UUID) may be used for the unique identifier. The UUID is a technique capable of assigning a unique identifier to a corresponding entity to identify and distinguish entities unknown to each other on a network. Generally, to ensure the uniqueness of object identifiers in the system, it is desirable to assign and manage a unique serial number to each object in a central management system. However, in an environment where simultaneous data transmission and reception occurs among multiple entities, such as a computer network, centralized management may be disadvantageous in terms of real-time processing. In particular, in vehicle platforms that perform real-time object recognition and provide autonomous driving or driver assistance systems by considering information on recognized objects, such as road networks, it would be desirable than a centralized system to assign a unique identifier for each entity connected to the network to independently distinguish each other, thereby to identify other party.

For example, the UUID was created to enable each entity connected to the network to easily identify each other in this non-centralized network environment, and is used as a standard by international organizations such as ITU (International Telecommunication Union) and OSF(Open Software Foundation).

Meanwhile, for a vehicle to which a unique identifier has been assigned, the server 1110 may predict or track the absolute coordinates of the corresponding vehicle. Therefore, to the extent that other vehicles recognize the corresponding vehicle, the unique identifier already assigned may be maintained. For example, if a vehicle with a unique identifier is unable to perform communication, the corresponding vehicle may not provide its vehicle number to the server 1110. However, other vehicles may continue to recognize the license plate number of the corresponding vehicle and provide the license plate number of the corresponding vehicle to the server 1110. Alternatively, even if it is difficult to recognize the corresponding vehicle number due to a recognition problem of the vehicle number, since other vehicles may still recognize the presence of the vehicle as long as the vehicle is driving, the relative coordinates of the corresponding vehicle may be continuously provided to the server 1110.

Therefore, if a vehicle has been assigned a unique identifier, even in situations where other vehicles may intermittently fail to recognize the corresponding vehicle number (due to issues such as a reduced recognition rate), as long as other vehicles still recognize the presence of the corresponding vehicle and the relative coordinates of the corresponding vehicle are consistently transmitted to server 1110, the relative coordinates continuously reported may be compared with the absolute coordinates of the vehicle predicted by the server 1110 since the server 1110 has already been predicting or tracking the location of the corresponding vehicle with the unique identifier. In this way, it is possible to determine whether a vehicle whose relative coordinates are reported without a vehicle number is the corresponding vehicle and estimate the absolute coordinates of the corresponding vehicle. However, even if a vehicle has been assigned a unique identifier, the unique identifier may not be maintained if the vehicle stops driving and other vehicles are unable to recognize the corresponding vehicle.

Meanwhile, the server 1110 may generate driving information and/or vehicle information for each unique identifier of vehicles based on driving information of the ego-vehicle and vehicle type/model information included in the ego-vehicle information. In other words, driving information and vehicle information of each vehicle may be generated based on driving information and vehicle information of the ego-vehicle transmitted by each vehicle capable of communicating with the server. Also, driving information (e.g., vehicle speed) for a vehicle unable to communicate with the server may be estimated by integrating the driving information of the individual vehicles.

As described above, the server 1110 may generate integrated traffic information (or integrated object information) based on the information collected from the individual vehicles 1130a, 1130b, 1130c. Then, at least part of the information may be transmitted to at least part of the vehicles 1130a, 1130b, 1130c. FIG. 11 illustrates an example in which the traffic information center 1110 provides traffic information to the vehicle 1130b through the RSU 1120a, and the vehicle 1130b relays the information to its neighboring vehicle 1130c through a side link.

In the above, an example has been described, in which one vehicle recognizes only other vehicles as surrounding objects and transmits the recognized information to the server 1110. However, each of the vehicles 1130a, 1130b, 1130c may also recognize pedestrians, streetlights, and occurrence of traffic accidents as surrounding objects and may transmit the relative coordinate information to the server 1110. In particular, the server 1110 collects the information, generates statistically processed C-ITS data, such as traffic conditions on the road, namely, average speed for each lane on the road, accident information, and traffic light recognition information, in real-time, and provides the generated data to the individual vehicles.

In what follows, based on the descriptions above, a specific example of integrated management of information of each vehicle will be described.

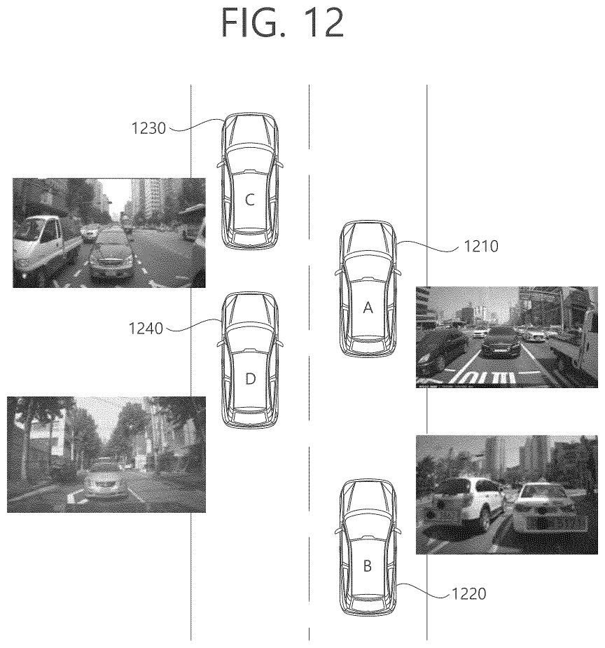

FIG. 12 illustrates one example of processing vehicle data according to one embodiment.

In FIG. 12, four vehicles A, B, C, D are driving on the road; each vehicle is equipped with a plurality of cameras, for example, at least a front camera and a rear camera and capable of recognizing surrounding objects. Also, each vehicle is equipped with a sensor, such as the radar/LiDAR sensor, and capable of calculating relative coordinates of surrounding objects with respect to the corresponding vehicle. Also, it is assumed that each vehicle is connected to a base station via a road side unit (RSU) or other vehicles (e.g., a side link) and may communicate with a server (not shown) through wireless communication.

In one embodiment, each vehicle may recognize an external vehicle using sensors such as a camera and a radar/LiDAR sensor and obtain the relative coordinates of the recognized external vehicle.

Referring to FIG. 12, vehicle A 1210 may recognize vehicle numbers of vehicle B 1220 and vehicle D 1240 in the rear using a rear camera and obtain relative coordinates of vehicle B 1220 and vehicle D 1240 with respect to vehicle A 1210. Vehicle B 1220 may recognize vehicle numbers of vehicle A 1210 and vehicle D 1240 in the front using a front camera and obtain relative coordinates of vehicle A 1210 and vehicle D 1240 with respect to vehicle B 1220. Vehicle C 1210 may recognize vehicle numbers of vehicle B 1220 and vehicle D 1240 in the rear using a rear camera and obtain relative coordinates of the corresponding vehicles. Vehicle D 1240 may recognize vehicle numbers of vehicle A 1210 and vehicle C 1230 using a front camera and obtain relative coordinates of the respective vehicles. Also, vehicle D 1240 may recognize the vehicle number of vehicle B 1220 using a rear camera and obtain the relative coordinates of vehicle B 1220.

Here, it is assumed that vehicle A 1210, vehicle B 1220, and vehicle C 1230 are ‘vehicles capable of communicating with a server (communicating vehicles)’, and vehicle D 1240 is a ‘vehicle incapable of communication (non-communicating vehicle).’

Vehicle A 1210, vehicle B 1220, and vehicle C 1230 may transmit their absolute coordinates to the server, but vehicle D 1240 may not transmit its absolute coordinates to the server. Therefore, the absolute coordinates of vehicle D 1240 should be determined based on information on the relative coordinates of vehicle D 1240 acquired by other vehicles A, B, C with respect to their ego-vehicles A, B, C. In this way, the server may assign a unique identifier to the non-communicating vehicle D 1240 by using the relative coordinates of the non-communicating vehicle D and vehicle number information received from the communicating vehicles A, B, C and also determine the absolute coordinates of the non-communicating vehicle D 1240.

Specifically, the server may receive the absolute coordinates of vehicle C 1230 and the relative coordinates of a vehicle having a first vehicle number with respect to the vehicle C 1230. Also, the server receives the absolute coordinates of vehicle B 1220 and the relative coordinates of a vehicle having a first vehicle number with respect to vehicle B 1220. The server may determine the absolute coordinates of the vehicle having the first vehicle number (which is vehicle D 1240) by combining the information received from vehicle C 1230 and vehicle B 1220. In other words, theoretically, the absolute coordinates of a non-communicating vehicle may be determined by using the information received from two vehicles. However, it should be noted that a larger number of vehicles used as the source of information would significantly improve the accuracy of the absolute coordinates.

Considering the factors above, when there is a high possibility that the accuracy of the absolute coordinates of a vehicle becomes low, for example, when the average speed of vehicles is very high, when the density of vehicles per unit area is large, or when the type of vehicle is a two-wheeled vehicle (motorcycle), the absolute coordinates of the non-communicating vehicle may be set to be determined by combining information received from a larger number of communicating vehicles.

Meanwhile, as described in FIG. 11, when the vehicle number of each vehicle is confirmed, a unique identifier of the corresponding vehicle may be generated from the vehicle number, and the vehicle may be identified using the unique identifier instead of the vehicle number. A unique identifier is used instead of a vehicle number because different vehicles may sometimes have the same vehicle number due to an administrative error. In other words, the vehicle number of a Genesis vehicle in Seoul and that of a BMW vehicle in Busan may be the same; in this case, an error may occur when integrated traffic information is generated.

Also, as described above with reference to FIG. 11, the server may additionally consider the absolute coordinates of each vehicle and driving information of communicating vehicles when generating integrated traffic information. In this case, since not only the current absolute coordinates of all communicating vehicles and non-communicating vehicles but also the absolute coordinates, vehicle speeds, and driving directions of communicating vehicles and non-communicating vehicles after a predetermined time period may be predicted, it is also possible to predict the driving speed for each lane in addition to the average driving speed for the entire road. Accordingly, more detailed and highly accurate integrated traffic information may be generated and provided to each vehicle.

FIG. 13 illustrates the operation of an electronic device within a vehicle according to one embodiment.

An electronic device within a vehicle may recognize a surrounding object and obtain information of the surrounding object(s) S1310. The information of the surrounding object may include the relative coordinates with respect to the ego-vehicle. Also, the information of the surrounding object may include information by which the surrounding object may be identified, for example, license plate information if the surrounding object is a vehicle.

The electronic device within the vehicle may transmit the information of the ego-vehicle together with the information of the surrounding object to the server S1320. The ego-vehicle information may include, for example, the absolute coordinates of the ego-vehicle. The absolute coordinates may be the latitude and longitude information of the ego-vehicle based on GPS information. The information of the ego-vehicle may include license plate information of the ego-vehicle. Typically, the ego-vehicle information is not stored in the vehicle; however, in one embodiment, the vehicle number information of the ego-vehicle may be pre-stored in the vehicle and transmitted to the server. Also, the information on the ego-vehicle may include driving information related to the destination, direction, and speed of the vehicle, such as navigation information of the ego-vehicle; the information may include information on the vehicle type or vehicle model.

The electronic device within the vehicle may receive integrated traffic information (or integrated object information) generated by the server S1330 and may reflect the received information to driving S1340.

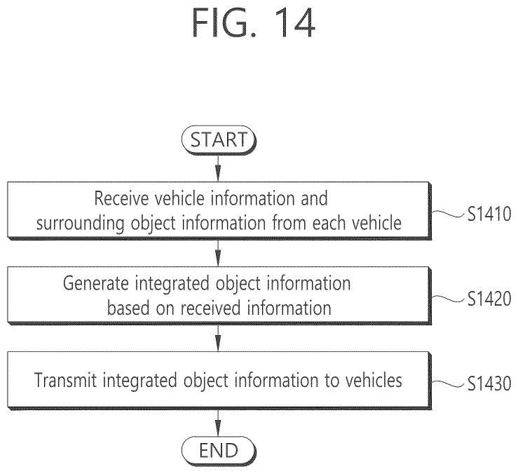

FIG. 14 illustrates the operation of an electronic device within a server according to one embodiment.

An electronic device within a server may receive vehicle information of the ego-vehicle and information of surrounding objects from each vehicle S1410 and generate integrated object information (i.e., integrated traffic information) based on the received information S1420. Also, the electronic device may transmit at least part of the generated integrated object information to at least part of the vehicles S1430.

For example, the information of the ego-vehicle may include the absolute coordinates of the ego-vehicle. The absolute coordinates may be the latitude and longitude information of the ego-vehicle based on GPS information. The information of the ego-vehicle may include license plate information of the ego-vehicle. Also, the information on the ego-vehicle may include driving information related to the destination, direction, and speed of the vehicle, such as navigation information of the ego-vehicle; the information may include information on the vehicle type or vehicle model.

The integrated object information may include information on conditions of external vehicles, pedestrians, traffic lights, road construction, and accidents.

In one example of generating the integrated object information, the server may generate unique identifiers of individual vehicles by using the license plate information of objects (i.e., vehicles) received from the respective vehicles. Also, the server may determine the absolute coordinates of the vehicles on the road using the absolute coordinates and the relative coordinates of the objects (i.e., vehicles) received from the individual vehicles.

In other words, the server may generate a unique identifier for a vehicle for which the vehicle number has been identified by integrating the vehicle number information of the ego-vehicles and vehicle number information of external vehicles received from the individual vehicles. Also, the absolute coordinates of the vehicle may be generated based on the absolute coordinates included in the information of the ego-vehicles and/or the relative coordinates of surrounding objects included in the information of the surrounding objects transmitted by the individual vehicles. Among the vehicles on the road, some vehicles may communicate with the server 1110 and transmit their absolute coordinates, while others are unable to communicate with the server. The absolute coordinates of the vehicle, which is unable to communicate with the server, may be derived by combining the relative coordinates of surrounding objects recognized by other vehicles capable of communicating with the server.

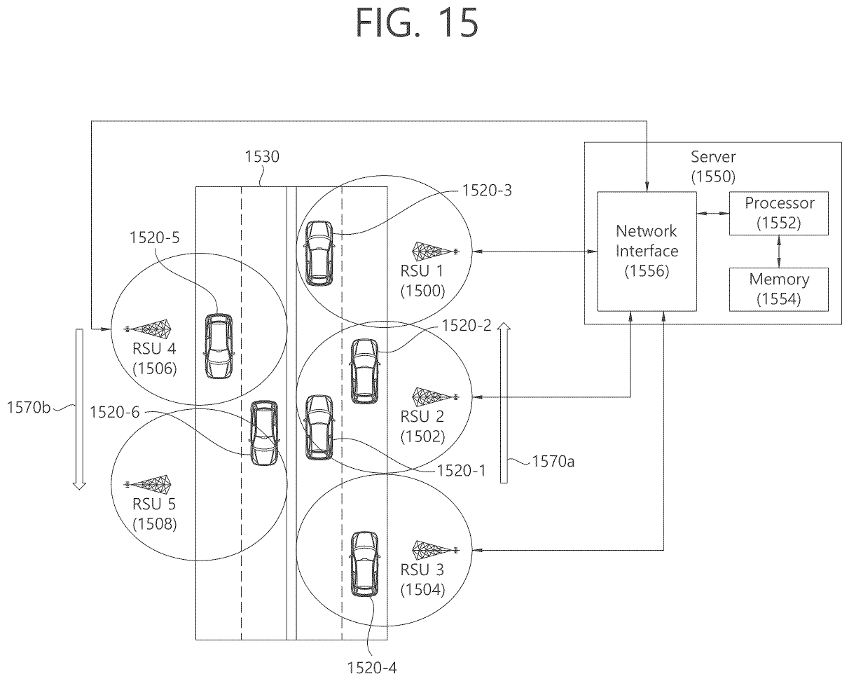

FIG. 15 is a diagram illustrating an example in which an ego-vehicle driving on a road network acquires absolute coordinate information of the ego-vehicle and relative coordinate information of surrounding vehicles according to an embodiment of the present invention.

Referring to FIG. 15, RSU 1 (1504) to RSU 5 (1508) are installed around the road 1530, and each RSU (RSU 1 (1504) to RSU 5 (1508)) is managed by the server 1550. For example, the processor 1552 of the server 1550 assigns an identifier (ID) to each RSU to identify the RSUs installed on the road 1530, maps the ID assigned to each RSU onto location information where each RSU is installed, and stores the assigned ID in memory 1554. Additionally, the processor 1552 of the server 1550 may communicate with each of the RSUs (RSU 1 (1500) to RSU 5 (1508)) through the network interface 1556.

Additionally, the processor 1552 of the server 1550 can wirelessly connect to the vehicle through the RSU whenever the vehicle enters or leaves the coverage of each RSU. Specifically, when a service provision request (autonomous driving service request, driving assistance information provision service request, driving guidance information provision request, etc.) is received from a vehicle that has entered the coverage of the RSU, the processor 1552 of the server 1550 identifies the serving RSU of the service requesting vehicle through RSU coverage where the requesting vehicle is located, generates a vehicle identifier to identify the service requesting vehicle, and transmits information for service provision to the vehicle corresponding to the generated vehicle identifier.

Referring again to FIG. 15, the ego-vehicle 1520-1 driving on the road 1540 and the surrounding vehicles 1520-2, 1520-3, 1520-4, 1520-5, and 1520-6) and RSUs 1500, 1502, 1504, 1506, and 1508 installed on the road 1540 are shown. And, in FIG. 15, reference number 1570a indicates the same direction as the driving direction of the ego-vehicle 1520-1, and reference number 1570b indicates the opposite direction to the driving direction of the ego-vehicle 1520-1.

In addition, the processor 1552 of the server 1550 obtains absolute coordinates information of the ego-vehicle 1520-1 based on the location information of RSU 2 (1502) which is the serving RSU of the ego-vehicle (1520-1) that requested service, and based on the location information of ego-vehicle (1520-1). For example, the processor 1552 of the server 1550 maps the location information of RSU 2 (1502) which is the serving RSU of the-ego-vehicle (1520-1) and the location information of the ego-vehicle (1520-1) as shown in Table 1 below and stores as absolute coordinate information in the memory 1554.

TABLE 1

| Absolute coordinate | |
|---|---|
| information field | Description |
| Location information | RSU ID, RSU latitude and longitude |
| of RSU | information |
| Location information | Latitude and longitude information (GPS |
| of ego-vehicle | location information) of the vehicle |
| | measured and transmitted by ego-vehicle |

In Table 1, the location information of RSU is information that the processor 1552 of the server 1550 can obtain in advance through the ID and location information assigned to each RSU, and is fixed which does not change unless there is a change in the road network. The location information of ego-vehicle is information that can be obtained after being received from the vehicle through the RSU, and varies depending on the location of the ego-vehicle. Based on the location of the ego-vehicle 1520-1 that has requested service and the serving RSU information of the ego-vehicle 1520-1, the processor 1552 of the server 1550 generates on the road network where surroundings of the ego-vehicle (1520-1) is located a virtual relative coordinate system which is a virtual mesh network, in order to calculate the relative location (relative location from the ego-vehicle 1520-1) of the neighboring vehicles (1520-2 1520-3, 1520-4, 1520-5, 1520-6) located around the ego-vehicle 1520-1 by using the generated absolute location after generating the absolute location of the ego-vehicle 1520-1.

In one embodiment of the present invention, the relative locations of all neighboring vehicles (1520-2, 1520-3, 1520-4, 1520-5, 1520-6) located around the ego-vehicle (1520-1) can be calculated, or only the relative location with respect to the road network where neighboring vehicles (1520-2, 1520-3, 1520-4) having the same driving direction (1570a) as the ego-vehicle (1520-1) are located can also be calculated.

In the present invention, absolute coordinate information represents fixed location information of an RSU that has already been installed on the road, and information indicating the absolute location of the RSU relative to the entire road network. And virtual relative coordinate information is a coordinate indicating the relative location between vehicles within the coverage of an RSU set in an absolute coordinate. With the ego-vehicle as the reference point (0, 0), the virtual relative information indicates the relative locations of the other vehicles from that reference point.

In addition, the processor 1552 of the server 1550 stores the absolute coordinate information and the virtual relative coordinate information in the memory 1554 according to an embodiment of the present invention. Whenever the location of the ego-vehicle changes, the processor 1552 of the server 1550 can update the absolute coordinate information and the virtual relative coordinate information stored in the memory 1554.

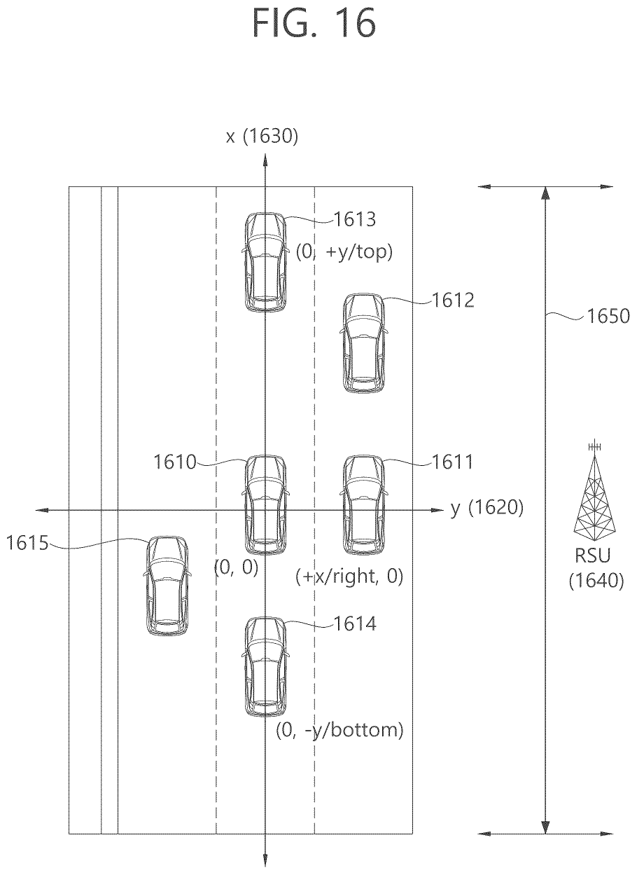

FIG. 16 is a diagram illustrating a method of obtaining absolute and relative coordinates of an ego-vehicle according to an embodiment.

Referring to FIG. 16, the ego-vehicle 1610 generates absolute coordinates of the global range based on the serving RSU 1640. The ego-vehicle 1610 sets the intersection point of the full-length center and the full-width center of the ego-vehicle 1640 as the origin (0, 0). And the ego-vehicle 1610 generates a virtual coordinate system of the x-axis (1620) and y-axis (1630).

At this time, according to one embodiment, the maximum range of the virtual coordinate system can be set as a distance 1650 including a portion of the front area and a portion of the rear area of the ego-vehicle 1610 on the road network, with respect to the area corresponding to the coverage of the serving RSU 1640 of the ego-vehicle 1610, or with respect to the serving RSU 1640, but the present invention is not limited to this.

Again in FIG. 16, the ego-vehicle 1610 may calculate the locations of surrounding vehicles in a virtual relative coordinate system based on the origin (0, 0).

Specifically, the ego-vehicle 1610 identifies the location of the vehicle 1611 as being located at a first distance away from the vehicle 1611 in the +x direction (right). The ego-vehicle 1610 identifies the location of the vehicle 1612 as being located in a first quadrant based on the origin (0, 0). The ego-vehicle 1610 identifies the location of the vehicle 1613 as being located at a location (0, +y/top) a predetermined distance away in the +y direction (up).

The ego-vehicle 1610 identifies the location of the vehicle 1615 as being located in a third quadrant based on the origin (0, 0). The ego-vehicle 1610 can identify the location of the vehicle 1614 as being located at a location (0, −y/bottom) a predetermined distance away in the −y direction (downward).

In the manner shown in FIG. 16, when measuring the locations of surrounding vehicles 1611, 1612, 1613, 1614, and 1615 using the location of the ego-vehicle 1613 as the origin (reference point), it can be difficult to determine the exact relative location.

Accordingly, in one embodiment, a virtual coordinate system in the form of a rectangular virtual mesh network with a size can be created by using the location of the vehicle 1613 as the origin (reference point).

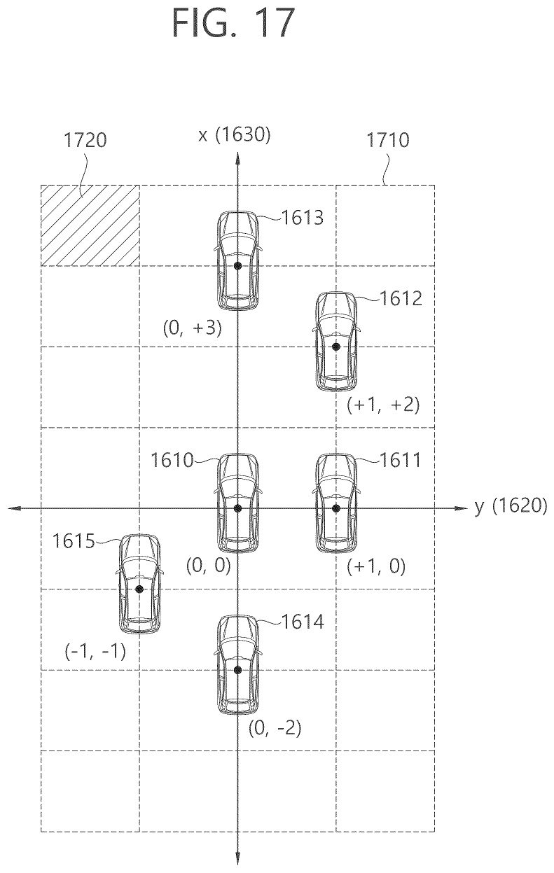

FIG. 17 is a diagram illustrating a virtual mesh network coordinate system in a rectangular shape which is generated with the location of the vehicle 1613 as the origin (reference point) according to an embodiment.

Referring to FIG. 17, the ego-vehicle 1610 identifies the location of the vehicle 1611 as (+1, 0) on a virtual mesh network coordinate system, identifies the location of the vehicle 1612 as (+1, +2) on a virtual mesh network coordinate system. Identifies the location of the vehicle 1613 is identified as (0, +3) on the virtual mesh network coordinate system, identifies the location of the vehicle 1614 is identified as (0, −2) on the virtual mesh network coordinate system, and identifies the location of the vehicle 1615 as (−1, −1) on the virtual mesh network coordinate system.

In FIG. 17, reference number 1720 represents one cell constituting a virtual mesh network coordinate system, may be configured as a square or rectangle, and may be configured differently depending on the road width of each country. For example, both the horizontal width and vertical width of one cell constituting the virtual mesh network coordinate system may be set to 5 m, or the horizontal width may be set to 3 m and the vertical width may be set to 5 m.

According to an embodiment of the present invention, the ego-vehicle 1610 acquires the above-described absolute coordinate information about itself and relative coordinate information about the surrounding vehicles 1611, 1612, 1613, 1614, and 1615, and transmits the acquired information to the server 1550 through the serving RSU 1640. When the server 1550 receives absolute coordinate information of the ego-vehicle 1610 and relative coordinate information of surrounding vehicles through the serving RSU 1640, the server 1550 can track information about the ego-vehicle 1610 and the surrounding vehicles 1611, 1612, 1613, 1614, 1615.

In an embodiment, it is explained that the electronic device of the ego-vehicle 1610 calculates relative coordinate information of the surrounding vehicles 1611, 1612, 1613, 1614, and 1615. However, the processor 1552 of the server 1550 can calculate relative coordinate information of the surrounding vehicles 1611, 1612, 1613, 1614, and 1615, and notifies the calculation result to the ego-vehicle 1610.

In addition, the relative coordinate information of the ego-vehicle 1610 and surrounding vehicles 1611, 1612, 1613, 1614, and 1615 according to an embodiment of the present invention may include the data shown in Table 2 below.

TABLE 2

| Field | Description |
|---|---|
| Ego-vehicle ID | Ego-vehicle identification information (unique |
| | information) |
| Time information | Relative coordinate information generation time |
| Surrounding vehicle | Identification information on a surrounding vehicle |
| ID | (temporary information) |
| Relative coordinate | Relative coordinate information corresponding to |
| information | surrounding vehicle ID |

In addition, the ego-vehicle may store sensing information corresponding to surrounding vehicle IDs in the memory along with the relative coordinate information shown in Table 2, or transmit them to the server through the serving RSU.

Specifically, the ego-vehicle can generate and store sensing information about surrounding vehicles along with relative coordinate information about the surrounding vehicles, as shown in Table 3 below.

TABLE 3

| Field | Description |
|---|---|
| Ego-vehicle ID | Ego-vehicle identification information (unique |
| | information) |
| Time information | Relative coordinate information generation time |
| Surrounding vehicle | Identification information on a surrounding vehicle |
| ID | (temporary information) |
| Relative coordinate | Relative coordinate information corresponding to |
| information | surrounding vehicle ID |
| Sensing information | Sensing data corresponding to the characteristics of |
| | sensors that sense surrounding vehicles |
| | 1) Vision sensor: Image frame for surrounding |
| | vehicles |
| | 2) Lidar sensor: Point cloud data about surrounding |
| | vehicles |
| | 3) Radar sensor: Radar signal information reflected |
| | from surrounding vehicles |

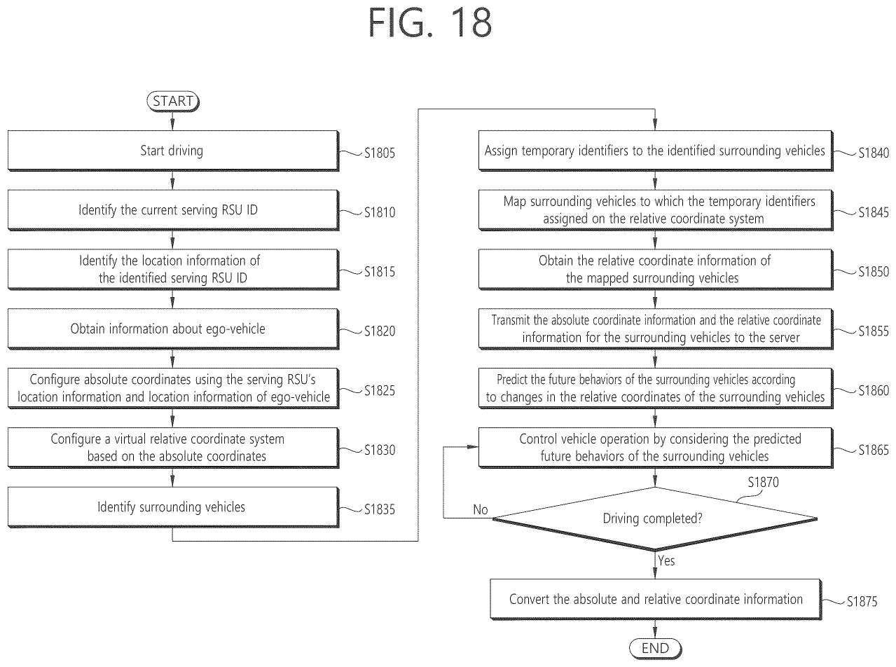

FIG. 18 is a flowchart of the operation of an ego-vehicle 1610 according to an embodiment. When the ego-vehicle 1610 starts driving (S1805), it identifies the current serving RSU ID (S1810). Then, the ego-vehicle 1610 identifies the location information of the identified serving RSU 1640 ID (S1815) and obtains its own location information (S1820). In step S1820, the ego-vehicle 1610 can identify its own location information using a GPS signal, etc.

The ego-vehicle 1610, which has identified its own location information in step S1820, sets absolute coordinates using the location information of the serving RSU 1640 and its own location information (S1825), and generates a virtual relative coordinate system based on the set absolute coordinates (S1830).

Then, when the virtual relative coordinate system is generated, the ego-vehicle 1610 identifies surrounding vehicles located around the ego-vehicle 1610 on the set relative coordinate system (S1835). The ego-vehicle 1610 assigns a temporary identifier to the identified surrounding vehicle (S1840), and maps the surrounding vehicle to which the temporary identifier is assigned onto the set relative coordinate system (S1845).

The ego-vehicle 1610 acquires relative coordinate information of the mapped surrounding vehicles (S1850), transmits the absolute coordinate information and the relative coordinate information for the surrounding vehicles to the server (S1855), and predicts the future movement of the surrounding vehicles according to changes in the relative coordinates of the vehicle (S1860).

In addition, the ego-vehicle 1610 considers the future behaviors of surrounding vehicles predicted in step S1860 and performs controlling vehicle behaviors (e.g., signal generation for steering wheel adjustment, braking, acceleration, etc.) for autonomous driving. (S1865). In addition, in step S1865, if the ego-vehicle's automation level can only implement functions that can provide autonomous driving or driver assistance information under limited conditions, the ego-vehicle can provide driving assistance information to the driver by considering the predicted future behaviors of surrounding vehicles.

Specifically, the ego-vehicle 1610 recognizes the surrounding situation of the ego vehicle 1610 using at least one of LiDAR, Radar, Computer vision, and high-precision maps mounted on the vehicle to control the vehicle operation in step S1865. Then the ego-vehicle 1610 identifies and tracks objects in the surrounding situation using deep learning/machine learning models.

The ego-vehicle 1610 identifies whether the driving has been completed (S1870), and if the driving has been completed (“Yes” in S1870), returns absolute coordinate information and relative coordinate information (S1875). If the driving is not completed (“No” in S1870), vehicle operation control continues in step S1865.

And, the step of S1870 can be identified by user input/manipulation.

The operation of FIG. 18 has been described as being performed by the electronic device of the ego-vehicle 1610, but this is only an example. The steps of FIG. 18, which include identifying the serving RSU ID of the ego-vehicle 1610 (step S1815), obtaining location information of the ego-vehicle 1610 (step S1820), setting absolute coordinates of the ego-vehicle 1610 (step S1825), setting a virtual relative coordinate system (step S1830), identifying surrounding vehicles located around the ego-vehicle 1610 (step S1835), allocating temporary identifiers to the surrounding vehicles (step S1840), mapping surrounding vehicles to which the temporary identifiers are assigned onto the relative coordinate system (step S1845), acquiring relative coordinate system information of surrounding vehicles mapped to the relative coordinate system (step S1850), predicting the future behaviors of the surrounding vehicles using the obtained relative coordinate system information of surrounding vehicles (step S1860), and generating a control command for controlling vehicle operation in consideration of the predicted future behaviors of the surrounding vehicles (step S1865), can be performed by the processor 1552 of the server 1550 (step S1865).

In order for the processor 1552 of the server 1550 to perform steps S1815, S1820, S1825, S1830, S1835, S1840, S1845, S1850, S1860, and S1865, the vehicle 1610, remote vehicle operation control services should be possible.

In the above-described present invention, the RSU is described as a subject that provides wireless access for the ego-vehicle to communicate with the server 1550, but this is only an example. It would be obvious that other entities such as eNode B, AP (Access Point) can also provide an air interface.

According to the embodiments described so far, in a road situation where communicating vehicles (e.g., autonomous driving vehicles) and non-communicating vehicles (non-autonomous driving vehicles) coexist, the locations and driving information of the non-communicating vehicles may be tracked and predicted using the information of non-communicating vehicles recognized and provided to the server by the communicating vehicles; therefore, a stable and accurate intelligent transport system may be built.

The embodiments of functions, methods, and procedures of a vehicle electronic device, a vehicle service providing server, and a user terminal proposed by the present disclosure may be executed through software. The constituting means of each function, method, and procedure are code segments executing required tasks. The program or code segments may be stored in a processor-readable medium or transmitted by means of a computer data signal coupled with a carrier wave over a transmission medium or a communication network.

The computer-readable recording medium includes all kinds of recording devices storing data that may be read by the computer. Examples of computer-readable recording media include ROM, RAM, CD-ROM, DVD-ROM, DVD-RAM, magnetic tape, floppy disk, hard disk, optical data storage device. Also, the computer-readable recording medium may be distributed over computer systems connected to each other through a network so that computer-readable codes may be stored and executed in a distributed manner.

Since various substitutions, modifications, and variations of the present disclosure may be made without departing from the technical principles and scope of the present disclosure by those skilled in the art to which the present disclosure belongs, the present disclosure is not limited to the embodiments described above and appended drawings. The embodiments of the present disclosure are not limited to the specific embodiments described above, but all or part of the embodiments may be combined selectively so that various modifications may be made to the embodiments.

### DESCRIPTION OF ELEMENTS

200: Service provision server
202: Communication unit
204: Processor
206: Storage unit
300: User terminal
302: Communication unit
304: Processor
306: Display unit
308: Storage unit
500: Autonomous driving system
503: Sensor(s)
505: Image preprocessor
507: Deep learning network
509: AI processor
511: Vehicle control module
513: Network interface
515: Communication unit

What is claimed is:

1. A method for an electronic device within a server processing data in an intelligent transport system, the method comprising:
receiving, from vehicles, information of an ego-vehicle including absolute coordinates of the ego-vehicle and information of surrounding objects including relative coordinates of the surrounding objects recognized by the ego-vehicle; and
generating integrated object information including absolute coordinates of the respective vehicles based on the received information.

2. The method of claim 1, wherein the information of the ego-vehicle includes license plate information of the ego-vehicle, and
when the surrounding object is a vehicle, the information of the surrounding object includes license plate information of the vehicle, which is the surrounding object.

3. The method of claim 2, wherein the generating of the integrated object information includes generating unique identifiers of a plurality of vehicles by using the license plate information of the ego-vehicle and the license plate information of the vehicles, which are the surrounding objects, the license plate information being received from the plurality of vehicles and
generating absolute coordinates of the vehicles with the generated unique identifiers.

4. The method of claim 3, wherein information of the ego-vehicle includes driving information of the ego-vehicle, wherein the driving information includes at least one of a moving direction, speed, and vehicle type of the ego-vehicle.

5. The method of claim 4, wherein the generating of the integrated object information includes generating driving information of vehicles with the unique identifiers based on driving information of the ego-vehicle.

6. The method of claim 1, wherein the vehicles include a plurality of communicating vehicles capable of communicating with the server and at least one non-communicating vehicle incapable of communicating with the server.

7. The method of claim 6, wherein the absolute coordinates of the non-communicating vehicle are generated based on the relative coordinates of the non-communicating vehicle received from at least two predetermined number of communicating vehicles among the plurality of communicating vehicles.

8. The method of claim 7, wherein the predetermined number is determined based on at least one of average speed of vehicles, density of vehicles, and vehicle types.

9. A method for an electronic device within a vehicle processing data in an intelligent transport system, the method comprising:
obtaining relative coordinates of a surrounding object recognized by the vehicle;
transmitting information of an ego-vehicle including absolute coordinates of the vehicle and information of a surrounding object including relative coordinates of the surrounding object to a server; and
receiving integrated object information including absolute coordinates of the respective external vehicles generated based on the transmitted information.

10. The method of claim 9, wherein the information of the ego-vehicle includes license plate information of the ego-vehicle, and
when the surrounding object is a vehicle, the information of the surrounding object includes license plate information of the vehicle, which is the surrounding object.

11. The method of claim 10, wherein the integrated object information includes absolute coordinates generated for a plurality of vehicles with unique identifiers generated using license plate information of the ego-vehicle and license plate information of the vehicles, which are the surrounding objects, the license plate information being received from the plurality of vehicles.

12. The method of claim 11, wherein the information of the ego-vehicle includes driving information of the ego-vehicle, wherein the driving information includes at least one of a moving direction, speed, and vehicle type of the ego-vehicle.

13. The method of claim 12, wherein the integrated object information includes driving information generated for the vehicles with the unique identifiers based on the driving information of the ego-vehicle.

14. The method of claim 9, wherein the external vehicles include a plurality of communicating vehicles capable of communicating with the server and at least one non-communicating vehicle incapable of communicating with the server.

15. The method of claim 14, wherein the absolute coordinates of the non-communicating vehicle are generated based on the relative coordinates of the non-communicating vehicle received from at least two or more predetermined number of communicating vehicles among the plurality of communicating vehicles.

16. The method of claim 15, wherein the predetermined number is determined based on at least one of average speed of vehicles, density of vehicles, and vehicle types.

17. An electronic device within a server processing data in an intelligent transport system, the device comprising:
a communication unit receiving, from vehicles, information of an ego-vehicle including absolute coordinates of the ego-vehicle and information of a surrounding object including relative coordinates of the surrounding object recognized by the ego-vehicle; and
a processor generating integrated object information including absolute coordinates of the respective vehicles based on the received information.

18. The device of claim 17, wherein the information of the ego-vehicle includes license plate information of the ego-vehicle, and
when the surrounding object is a vehicle, the information of the surrounding object includes license plate information of the vehicle, which is the surrounding object.

19. An electronic device processing data within a vehicle in an intelligent transport system, the device comprising:
a processor obtaining relative coordinates of a surrounding object recognized by the vehicle;
a communication unit transmitting information of an ego-vehicle which includes absolute coordinates of the vehicle and information of a surrounding object including relative coordinates of the surrounding object to a server, and receiving integrated object information including absolute coordinates of the respective external vehicles generated based on the transmitted information.

20. The device of claim 19, wherein the information of the ego-vehicle includes license plate information of the ego-vehicle, and
when the surrounding object is a vehicle, the information of the surrounding object includes license plate information of the vehicle, which is the surrounding object.
